(19) United States
(12) Patent Application Publication
(10) Pub. No.: US 2015/0176654 A1
(43) Pub. Date: Jun. 25, 2015

(54) ROLLING-ELEMENT BEARING INCLUDING SEAL UNIT

(71) Applicants: Femke Back, Schweinfurt (DE); Jens Bettenhausen, Würzburg (DE); Steffen Hain, Karlstadt (DE); Matthias Hofmann, Schweinfurt (DE); Henning Kern, Schweinfurt (DE); Jochen Lorenscheit, Rimpar (DE); Christina Pfeuffer, Eussenheim (DE); Edgar Pickel, Sommerach (DE); Werner Schleyer, Reckendorf (DE); Mathias Seuberling, Grosseibstadt (DE); Matthias Krebs, Neckargemünd-Dilsberg (DE)

(72) Inventors: Femke Back, Schweinfurt (DE); Jens Bettenhausen, Würzburg (DE); Steffen Hain, Karlstadt (DE); Matthias Hofmann, Schweinfurt (DE); Henning Kern, Schweinfurt (DE); Jochen Lorenscheit, Rimpar (DE); Christina Pfeuffer, Eussenheim (DE); Edgar Pickel, Sommerach (DE); Werner Schleyer, Reckendorf (DE); Mathias Seuberling, Grosseibstadt (DE); Matthias Krebs, Neckargemünd-Dilsberg (DE)

(73) Assignees: AKTIEBOLAGET SKF, Goteborg (SE); SKF ECONOMOS DEUTSCHLAND GMBH, Bietigheim-Bissingen (DE)

(21) Appl. No.: 14/575,174

(22) Filed: Dec. 18, 2014

(30) Foreign Application Priority Data
Dec. 19, 2013 (DE) 10 2013 226 555.7

(51) Int. Cl. F16C 33/80

(52) U.S. Cl. CPC F16C 33/805

(57) ABSTRACT

A rolling-element bearing including a seal unit, the rolling-element bearing having at least one bearing ring and a further bearing ring tiltable with respect to the at least one bearing ring by a limited angle, and the seal unit having an at least part-ring shaped element attached to the bearing ring. The at least part-ring shaped element delimits a labyrinthine seal gap and corresponds to a first delimiting element, the rolling-element bearing further includes a second delimiting element and a third delimiting element, the third delimiting element being attached to a bearing cage, and the seal gap extends at least partially between the first delimiting element, the second delimiting element and the third delimiting element.

### CROSS-REFERENCE

This application claims priority to German patent application no. 10 2013 226 555.7 filed on Dec. 19, 2013, the contents of which are fully incorporated herein by reference.

### TECHNOLOGICAL FIELD

The present disclosure is directed to the field rolling-element bearing seals.

### BACKGROUND

Known bearing seals can protect a rolling-element bearing against dirt and contamination. However, these seals are generally configured for use with a bearing of a particular type or size and can only be adapted with difficulty for use with other bearings. This limits the number of each seal made and requires manufacturing seals of many different sizes and shapes. In addition, it can be difficult to replace an installed seal because a complex and cost-intensive disassembly effort is often needed to remove parts to allow the seal to be replaced. This is a particular problem in the field of large bearings having a diameter of approximately 400 millimeters or larger, bearings used, for example, in wind turbines.

FIG. 36 illustrates a conventional seal in a large bearing 112 as a comparative example. The large bearing 112 is sealed on two sides by so-called labyrinths (labyrinth seals) 140 which are formed by labyrinth rings 114. The seal is accordingly composed of labyrinth rings 114 provided on both sides that form labyrinth-shaped sealing gaps, the so-called labyrinths 140. The meandering geometry of the labyrinths 140 thus formed makes it harder for foreign matter to penetrate into the region to be sealed, for example, to the rolling elements 130 or the raceways of the bearing rings 120. In this seal variant, all of the intervening spaces of the labyrinth 140 and also of the rolling-element bearing 112 are usually filled with grease or lubricant. In addition, a supporting, so-called V-ring 116 can be used on or in the labyrinth 140. The sealing effect can be additionally supported by periodic relubrication. All of the components mentioned can be cost factors. Moreover, the labyrinth rings 114 forming the labyrinth 140 extend beyond the width of the actual rolling-element bearing 112, in other words beyond the width of the bearing ring 120, and can thereby occupy valuable space inside a machine. The most massive embodiments of the labyrinth rings 114, for example, those made from cast iron such as grey cast iron, create further assembly and operational disadvantages due to their own weight.

Large bearings can also be protected by contacting sealing rings. These may comprise radial shaft seal rings, possibly including upstream dust lips, which are held in position using, e.g., cast support parts. These support parts likewise constitute a large mass and thus a large weight to be moved during assembly. This makes it impossible or at the very least difficult and expensive, to exchange the seal ring.

The two above-mentioned sealing concepts have the segregation from the rolling-element bearing in common. Therefore, the bearings can only be filled with lubricant in the assembled state. Such seals can only be installed after the assembly of the bearing, and only thereafter can the bearing be filled with lubricant.

In addition, integrated sealing concepts are known which are embodied purely from elastomer, and may be, e.g. bellows-shaped (see German patent document DE 10 2007 036 891 A1). Bearings with such seals scan be prelubricated—at a factory before delivery, for example. However, it may be difficult to achieve (or adequately achieve) the required seal system stiffness for large bearing diameters. Moreover, due to the closed geometry of the seal ring, it may be difficult or impossible to exchange the seal without disassembling the rolling-element bearing.

The existing sealing concepts discussed herein also accommodate only a limited bearing misalignment or tilt and fail to provide adequate sealing when a maximum tilt is exceeded. Especially in the case of self-aligning bearings, such as spherical roller bearings or compact aligning roller bearing (CARB) toroidal roller bearings, the maximum possible tilting of a bearing inner ring with respect to a bearing outer ring can be severely limited by conventional seals. This can lead, during installation of the bearing or in actual operation, to a rolling-element bearing roller bumping against the seal element. This in turn may damage the roller set, the seal element, or even the attachment mechanism on the respective bearing ring and lead to significant repair costs or an impairment of the service life of the bearing.

In addition, the support parts of the contacting sealing rings can also be manufactured from welded metal-plate structures and integrated in the rolling-element bearing so that no components extend beyond the external dimensions of the rolling-element bearing. In this case an exact aligning/centering of the seal lips to the associated seal countersurface (opposite seal contact surface) should occur via a defined reference position on the component (e.g. outer ring) supporting the seal lip. In these cases the reference position is realized by circulating reference grooves, reference surfaces, reference bores, reference edges, or the like. Due to the precision required in positioning these reference indicia, they must be produced by expensive and high-precision processes, such as, for example, hard turning. The methods mentioned are associated with high manufacturing costs. Furthermore, if components are disposed between the reference position on the supporting component and the seal lip to be centered, these must also be precisely positioned in order to maintain the necessary precision in view of the tolerance chain. These alignment requirements of the components are also associated with effort and cost.

In all seal concepts with contacting seal rings there can be significant friction losses depending on the quality of the paired surfaces (seal lip to countersurface). These energy losses could far exceed the actual power dissipation of the rolling-element bearing. Furthermore, signs of wear are also associated with the friction losses mentioned. In addition, the seal (seal lip) and the associated countersurface wear over their service lives, and after reaching a certain wear condition the seal ring should be replaced. A repair is much more difficult with worn countersurfaces. With external sealing concepts in the field, any scratches/scoring/markings/physical wear can be eliminated by so-called wear sleeves; however the installation of wear sleeves is complex and expensive. On the other hand, with integrated seal concepts, repair methods can be difficult or even impossible.

### SUMMARY

There is therefore a need to provide an improved concept for sealing rolling-element bearings.

Exemplary embodiments provide a rolling-element bearing including a seal unit. The rolling-element bearing comprises at least one bearing ring, and the seal unit comprises an at least part-ring shaped element attached to the bearing ring. The at least part-ring shaped element delimits a labyrinthine seal gap.

The rolling-element bearing can be, for example, a ball bearing, a barrel roller bearing, a tapered roller bearing, or a bearing including a single-row or multi-row arrangement of rolling elements. The first bearing ring may be attached to a stator. The second bearing ring may be attached to a rotor. Both the first bearing ring and the second bearing ring could respectively be an inner bearing ring or an outer bearing ring.

In some exemplary embodiments the seal unit is manufactured at least partially from a flexible, elastic material. For this purpose elastomers, for example, certain types of plastic or rubber-type materials, can be used. The term “seal unit” indicates that a penetration of certain substances from one side of the seal unit to the other is to be prevented. These substances can include dirt particles (e.g. soot, fine dust, sand, or mud), gases or vapors (e.g. oxygen, vapors of fuels or solvents, or also vapors of toxic or corrosive substances) or liquids (e.g. water, acids, lyes, oil), or also materials such as, greases. Moreover, the seal unit could be manufactured at least partially from metal, metal alloys, particularly low-friction plastics such as polytetrafluoroethylene (PTFE), or plastics having a high stiffness. Plastics having high stiffness could be so-called thermosets (thermosetting materials). Furthermore, the materials used could make possible a mass production by methods such as injection molding, vulcanization, etc. Production costs and material costs as well as weight can thus be reduced.

An at least part-ring shaped element can be formed by a complete ring, or also by parts of a ring, for example by segments. In addition to ring segments, however, embodiments are also possible in which a ring can be assembled from parts having irregular shapes. An embodiment in which the ring is formed from a plurality of parts could significantly facilitate maintenance since the installation and removal can occur without requiring a complete removal of the entire rolling-element bearing. If the element is segmented, a connection of the individual segments can be formed by using connecting plates, screws, adhesion, or welding.

In exemplary embodiments the attaching can occur in an interference-fit, friction-fit, or materially-bonded manner. Possible attachment means could comprise, for example, a screw, an adhesive surface, a welded surface, a soldered joint, a rivet, a bore, a thread, or a system including a groove and spring.

Moreover, in some exemplary embodiments the seal unit can be integrated into an already-existing rolling-element bearing. Due to its simple construction, this concept could be used on any rolling-element bearing, independent of design, bearing series, or diameter. The seal unit could thus be used flexibly. Compared to the conventional solution of the labyrinth seal, such as is used, for example, in wind turbines, the space to be filled by a lubricant could be substantially reduced and thus allow for the use of a smaller amount of lubricant. Moreover, in some exemplary embodiments the seal unit can be made from lightweight material. This could lead to a reduction of material costs and a weight reduction and thus allow a simplified, time-efficient installation. A factory prelubrication could make more difficult, or even prevent, a contamination during installation of the otherwise unsealed, open bearing.

A labyrinth or a labyrinthine seal gap refers to a structure that makes it difficult or impossible for contaminants to penetrate. This is because every possible path for penetration of substances through such a seal gap requires at least one change of direction. Such a change of direction of the path can be a change of direction from an axial direction to a radial direction. In general a change of direction can refer to a point at which two partial sections of a path meet such that they inevitably form an angle different from 180°. In other words, if a structure is sealed using a labyrinthine seal gap, there is no straight path from an exterior of the structure to an interior of the structure. A straight path between two points A and B could be represented as a direct line-of-sight from A to B. In addition, in some exemplary embodiments the labyrinthine seal gap can be filled with lubricant in order to increase the sealing effect. A labyrinthine gap could be contactless, i.e. the components which delimit the labyrinthine gap could be configured such that they generally do not come into contact under normal operating conditions. Wear occurring on the rolling-element bearing or the seal unit could thus be reduced or even minimized.

In some exemplary embodiments the seal unit can be mounted on the rolling-element bearing even before the rolling-element bearing is supplied to its actual intended purpose, i.e. for example mounted on a rotor or on a stator. A rolling-element bearing could also be filled with lubricant before it is mounted.

Optionally at least part of the seal gap does not extend beyond the bearing ring in the axial direction. In other words, dimensions of the bearing relevant to an installation (width, inner diameter, outer diameter) are not changed by providing the labyrinthine seal gap. Or in other words, the seal gap can lie completely between two bearing rings. The bearing rings can be an inner and an outer bearing ring, and can at least partially delimit the seal gap.

In exemplary embodiments the element is optionally formed in the shape of a plate. A plate-shaped element can also be understood to be a thin element; in other words, one of the three spatial dimensions (thickness) could be very small with respect to the other two spatial dimensions (length, width). In exemplary embodiments the thickness could respectively be up to 1%, 2%, 5%, 10%, etc. of the length or width. Using the plate-shaped form of the element, weight and material can be saved, as well as costs and effort associated therewith, for example in production or maintenance. Furthermore, the volume of the seal unit could be reduced so much that large amounts of installation space are saved. In some exemplary embodiments the element could even end flush with the bearing ring, i.e. not extend beyond the bearing ring in the axial direction. It could thereby be possible, for example, to maintain an installation space specified by the International Organization for Standardization (ISO).

Additionally or alternatively the seal gap may also be delimited by a recess in the bearing ring. Such a recess can be a groove. The groove or the recess can also have an extension in the axial direction which is greater than the thickness (axial extension) of the plate-shaped element. In the case of a spherical roller bearing, wherein two bearing rings can be tilted with respect to each other, a known clearance could be maintained for the element during tilting. The clearance could be maintained even during the tilting of a spherical roller bearing, and thus the sealing effect of the seal gap would also be maintained.

Additionally or alternatively, in exemplary embodiments the bearing ring includes a seal lip in abutment with the element. In some exemplary embodiments, the seal lip can be manufactured at least partially from a seal material. A seal material can be, for example, a plastic, e.g. polyurethane, nitrile rubber (nitrile butadiene rubber (NBR), hydrated nitrile butadiene rubber (HNBR)), depending on the type of material that is to be prevented from penetrating or escaping.

In some exemplary embodiments the seal lip can completely close the seal gap and thus further increase the sealing effect. The seal lip can also contact the element or the bearing ring at an acute angle (smaller than 90°) open towards a direction of the seal gap which points towards a rolling element of the rolling-element bearing. In this way the penetration of substances (i.e., for example, dirt particles or moisture) could be made more difficult, and an escape of excess lubricant could be facilitated. Furthermore, friction and associated wear occurring during operation of the rolling-element bearing could occur on the seal lip instead of on the bearing ring, so that the wear on the bearing ring could be substantially lower. The expense for replacing (and thus the maintenance effort and the maintenance costs) for the seal lip would also not be as great as the expense for replacing the bearing ring.

Additionally or alternatively, in some exemplary embodiments the element has a change of direction along its course of at least 45°. In other exemplary embodiments a change of direction could occur in any desired angle. A course of the labyrinthine passage which is delimited by the element can thus be extended by additional changes of direction, and a penetration of contaminants could thus be made more difficult. The change of direction takes place in a cross-sectional plane which comprises an axis of rotation of the bearing. In other words, the cross-sectional area of the element includes the change of direction.

Additionally or alternatively, the element corresponds to a first delimiting element, and the rolling-element bearing further comprises a second delimiting element, wherein the seal gap extends at least partially between the first and the second delimiting element. However, in further exemplary embodiments the element could equally correspond to the second delimiting element. Both delimiting elements can be plate-shaped, part-ring shaped, ring-shaped, and/or be manufactured from the same or from different materials. The seal gap could even extend completely between the two delimiting elements. Due to the presence of two delimiting elements, the seal gap could be additionally extended and its sealing effect could thereby be increased. The second delimiting element could also be attached to a bearing ring.

In such an exemplary embodiment, wherein the seal gap extends at least partially between the first and the second delimiting elements, the rolling-element bearing can additionally or alternatively include a third delimiting element attached to a bearing cage. The seal gap extends at least partially between the first delimiting element, the second delimiting element, and the third delimiting element. Moreover, the third delimiting element can have the same features as the first and second delimiting element (i.e. it can be plate-shaped, part-ring shaped, ring-shaped, and manufactured from the same materials as the first and the second delimiting element, or from other materials).

In some exemplary embodiments the two or three delimiting elements can also differ in particular with respect to these features. For example, the first and the second delimiting elements may be attached to different bearing rings. An unwanted escape of lubricant can thereby be prevented. This could additionally be improved or optimized by the part of the gap extending between the first delimiting element and the second delimiting element being disposed as centrally as possible (i.e. as far as possible from both bearing rings).

Additionally or alternatively, in exemplary embodiments the seal gap additionally includes a flocking and/or a seal lip. A flocking could serve as an additional filter which makes it more difficult for dirt particles to enter the bearing. As described above, a seal lip can make it harder for contaminants to enter the bearing and simultaneously also facilitate an escape of excess lubricant. The seal lip could in turn be manufactured from an elastomer, or generally from high-flexibility materials. The flocking could be manufactured from textile fibers whose desired strength or length is selectable depending on the application.

In some exemplary embodiments, at least the element is additionally or alternatively exchangeably attached to the bearing ring. In further exemplary embodiments this can accordingly also be the case for the first delimiting element or the second delimiting element. The third delimiting element can also be exchangeably connected to the bearing cage. Furthermore, in some exemplary embodiments the seal lip connected to the bearing ring or located in the seal gap can be exchangeably connected to the element or the bearing ring. “Exchangeably connected” as used herein means that a low-effort removal is possible (for example without using a tool), that a damage-free removal is possible, that a connection is releasable and restorable, that the element or the seal lip is repeatedly connectable or exchangeable, or that the element or the seal lip is reversibly connectable. Due to the exchangeable connectability, installation and maintenance processes can be accelerated and simplified. In addition damage to the seal elements or bearing elements during a removal of the element or of the seal lip can be prevented.

In exemplary embodiments the rolling-element bearing additionally or alternatively comprises a further bearing ring which is tiltable with respect to the bearing ring by a limited angle. This occurs, for example, in a spherical roller bearing. The maximum possible tilting of two bearing rings with respect to each other can be a fraction of a degree, but also a plurality of degrees, for example 2 or 3 degrees. In an exemplary embodiment the seal unit can be attached on an inner bearing ring so that a collision with the rolling elements during a tilting of the two bearing rings with respect to each other can be avoided. The use of a seal lip, which can be manufactured, for example, from elastomer, could provide so much clearance during tilting that the sealing function of the seal lip is maintained even with a tilting of one or two degrees. If the seal unit is attached to the outer bearing ring, manufacturing the seal unit from plastic could significantly reduce damage during severe tilting of both bearing rings with respect to each other, which damage could result from a collision of the seal unit with the rolling elements.

Additionally or alternatively the rolling-element bearing has an external radius or an external diameter of at least 400 mm. The diameter or the radius can be measured radially to an axis of rotation of the bearing. Bearings having an outer diameter or outer radius of 400 mm or more are often referred to as “large bearings.” Large bearings can be used, for example, in the field of energy generation (e.g. wind turbines, underwater turbines, turbines in general). Maintenance, installation, or replacement of a conventional seal in a large bearing can be expensive. The embodiment of the element as a plurality of disk-parts or ring-parts could significantly reduce this expense. A sealing of large bearings using the described seal unit could save significant amounts of material and also reduce weight. Manufacturing costs and manufacturing effort could also be reduced to a considerable degree. Mounting the seal unit on the bearing could also occur before as well as after the installation of the bearing itself.

Furthermore, in exemplary embodiments the seal unit additionally or alternatively has at least one liquid-permeable bore or grease outlet. If such grease outlet bores are incorporated in the seal unit, used lubricant could be discharged or pumped in an efficient and directed manner using, e.g., hoses/tubes or collecting tanks attached directly to the bores, and the metering of the lubricant escape could additionally be regulated via the gap formed. The contamination of surrounding components and of the surrounding space could thus be avoided.

### BRIEF DESCRIPTION OF THE DRAWINGS

Exemplary embodiments are described and explained in more detail below with reference to the accompanying Figures:

FIG. 1 shows a detail view of a seal unit in a rolling-element bearing according to a first exemplary embodiment.

FIG. 2 shows a rolling-element bearing including a seal unit in overview according to a first exemplary embodiment.

FIG. 3 shows a cross-section through a rolling-element bearing including a seal unit in side view according to a first exemplary embodiment.

FIG. 4 shows a cross-section through a rolling-element bearing including a seal unit in perspective view according to a first exemplary embodiment.

FIG. 5 shows a detail view of a seal unit in a rolling-element bearing according to a second exemplary embodiment.

FIG. 6 shows a further detail view of a seal unit in a rolling-element bearing according to a second exemplary embodiment.

FIG. 7 shows a rolling-element bearing including a seal unit in overview according to a second exemplary embodiment.

FIG. 8 shows a cross-section through a rolling-element bearing including a seal unit in side view according to a second exemplary embodiment.

FIG. 9 shows a cross-section through a rolling-element bearing including a seal unit in perspective view according to a second exemplary embodiment.

FIG. 10 shows a seal lip according to a third exemplary embodiment.

FIG. 11 shows an installation of a seal lip based on a third exemplary embodiment.

FIG. 12 shows a detail view of a seal unit including a seal lip in a rolling-element bearing according to a third exemplary embodiment.

FIG. 13 shows a further detail view of a seal unit in a rolling-element bearing according to a third exemplary embodiment.

FIG. 14 shows a still further detail view of a seal unit in a rolling-element bearing according to a third exemplary embodiment.

FIG. 15 shows a rolling-element bearing including a seal unit in overview according to a third exemplary embodiment.

FIG. 16 shows a cross-section through a rolling-element bearing including a seal unit in side view according to a third exemplary embodiment.

FIG. 17 shows a cross-section through a rolling-element bearing including a seal unit in perspective view according to a third exemplary embodiment.

FIG. 18 shows a further variant of a seal unit according to a third exemplary embodiment.

FIG. 19 shows a further variant of a seal unit in detail view according to a third exemplary embodiment.

FIG. 20 shows a still further variant of a seal unit according to a third exemplary embodiment.

FIG. 21 shows a still further variant of a seal unit in detail view according to a third exemplary embodiment.

FIG. 22 shows a detail view of a seal unit in a rolling-element bearing according to a fourth exemplary embodiment.

FIG. 23 shows a further detail view of a seal unit in a rolling-element bearing according to a fourth exemplary embodiment.

FIG. 24 shows a seal unit according to a fourth exemplary embodiment in a spherical roller bearing.

FIG. 25 shows a further example of a seal unit according to a fourth exemplary embodiment in a spherical roller bearing.

FIG. 26 shows a rolling-element bearing including a seal unit in overview according to a fourth exemplary embodiment.

FIG. 27 shows a cross-section through a rolling-element bearing including a seal unit in side view according to a fourth exemplary embodiment.

FIG. 28 shows a cross-section through a rolling-element bearing including a seal unit in perspective view according to a fourth exemplary embodiment.

FIG. 29 shows a detail view of a seal unit in a rolling-element bearing according to a fifth exemplary embodiment.

FIG. 30 shows a detail view of a seal unit including a seal lip in a rolling-element bearing according to a fifth exemplary embodiment.

FIG. 31 shows a detail view of a seal unit including a seal lip and flocking in a rolling-element bearing according to a fifth exemplary embodiment.

FIG. 32 shows a detail view of a seal unit including flocking in a rolling-element bearing according to a fifth exemplary embodiment.

FIG. 33 shows a rolling-element bearing including a seal unit in overview according to a fifth exemplary embodiment.

FIG. 34 shows a cross-section through a rolling-element bearing including a seal unit in side view according to a fifth exemplary embodiment.

FIG. 35 shows a perspective view of a seal unit in a rolling-element bearing according to a fifth exemplary embodiment.

FIG. 36 shows a conventional construction of a labyrinth seal as a comparative example.

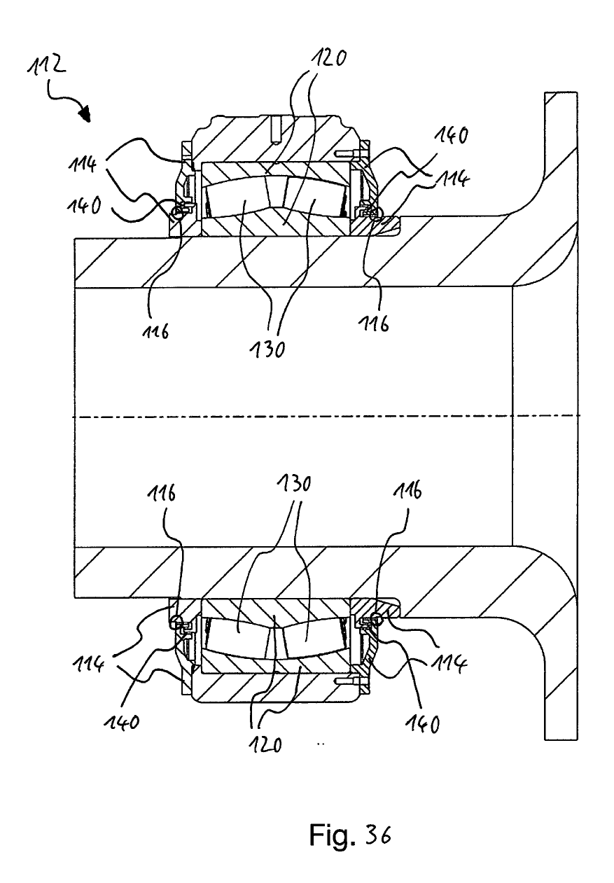

### DETAILED DESCRIPTION

In the following description of the accompanying Figures, which show exemplary embodiments of the present disclosure, identical reference numerals indicate identical or comparable components. Furthermore, summarizing reference numerals may be used for components and objects that appear multiple times in an exemplary embodiment or in an illustration, but that are described together in terms of one or more common features. Components or objects that are described with the same or summarizing reference numerals can be embodied identically, but also optionally differently, in terms of individual, multiple, or all features, their dimensions, for example, as long as the description does not explicitly or implicitly indicate otherwise.

In the following, lower-case letters “a,” “b,” “c,” “d,” and “e” appended to a reference number respectively refer to different exemplary embodiments. Thus, for example, the reference numbers “10a” and “10b” can indicate two counterparts/instances of the same component in respective different embodiments.

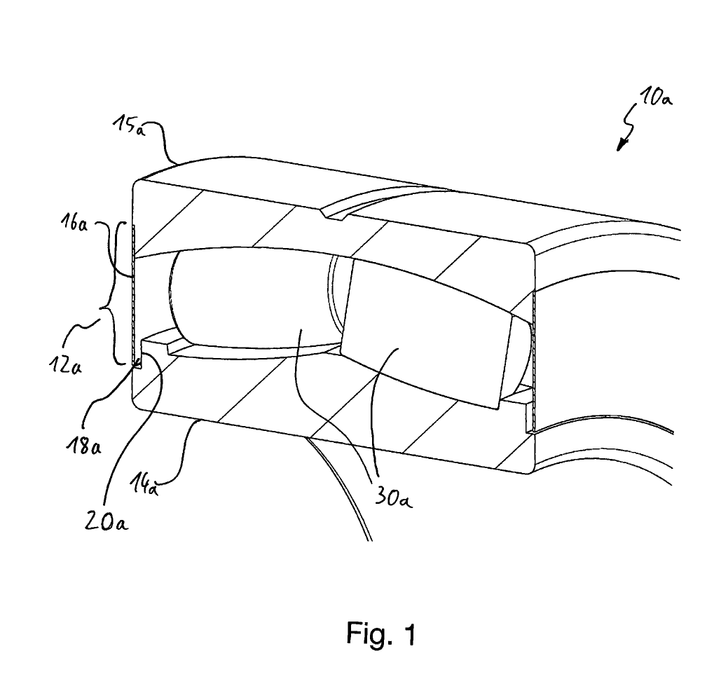

In the following five exemplary embodiments (see FIGS. 1-35), the bearing ring 14a; 14b; 14c; 14d; 14e; 15a; 15b; 15c; 15d; 15e can be a bearing inner ring or a bearing outer ring. If it is a bearing inner ring, it is henceforth identified by the reference numbers 14a; 14b; 14c; 14d; 14e. If it is a bearing outer ring, it is henceforth identified by the reference numbers 15a; 15b; 15c; 15d; 15e. In the following exemplary embodiments, the further bearing ring 15a; 15b; 15c; 15d; 15e; 14a; 14b; 14c; 14d; 14e corresponds to the respective opposing part of the bearing ring 14a; 14b; 14c; 14d; 14e; 15a; 15b; 15c; 15d; 15e. In other words, the further bearing ring 15a; 15b; 15c; 15d; 15e; 14a; 14b; 14c; 14d; 14e is an inner ring if the bearing ring 14a; 14b; 14c; 14d; 14e; 15a; 15b; 15c; 15d; 15e is an outer ring, and vice versa.

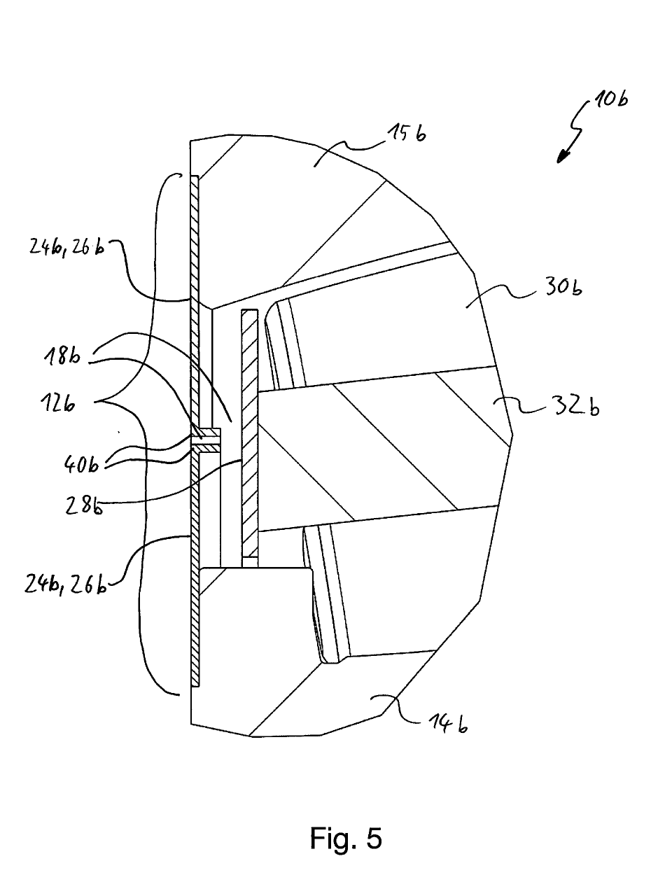

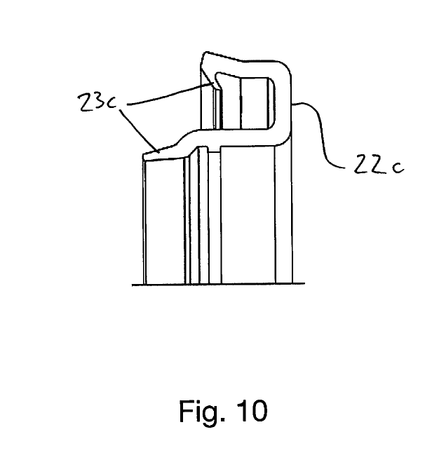

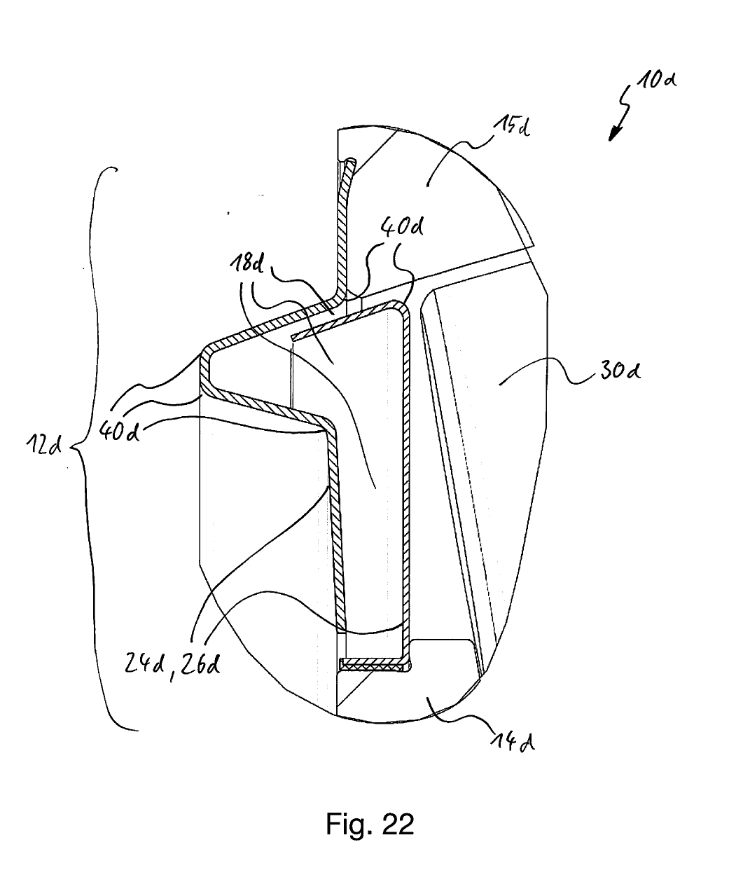

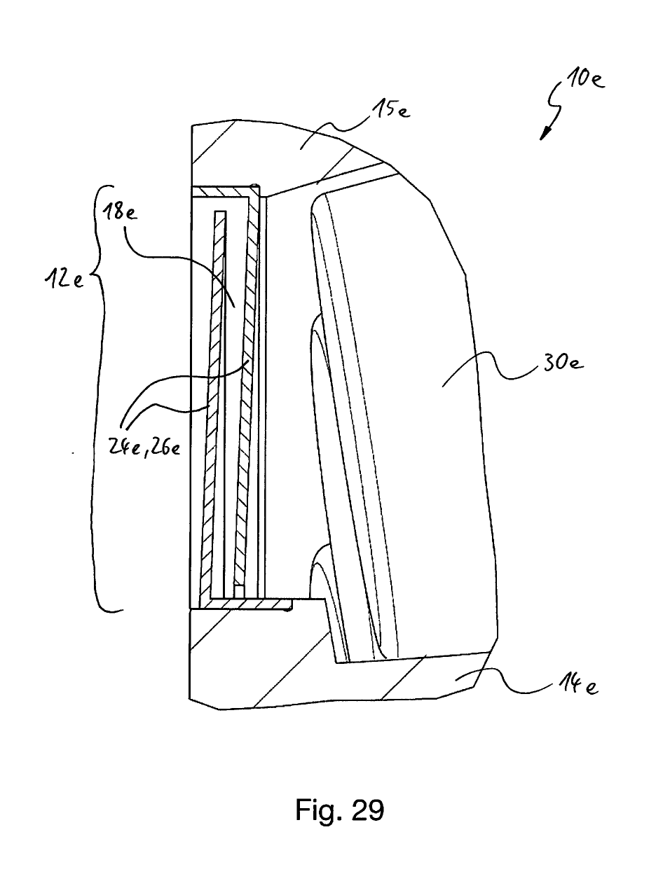

In description that follows, a first exemplary embodiment is described with reference to FIGS. 1-4, a second exemplary embodiment is described with reference to FIGS. 5-9, a third exemplary embodiment is described with reference to FIGS. 10-21, a fourth exemplary embodiment is described with reference to FIGS. 22-28, and a fifth exemplary embodiment is described with reference to FIGS. 29-35.

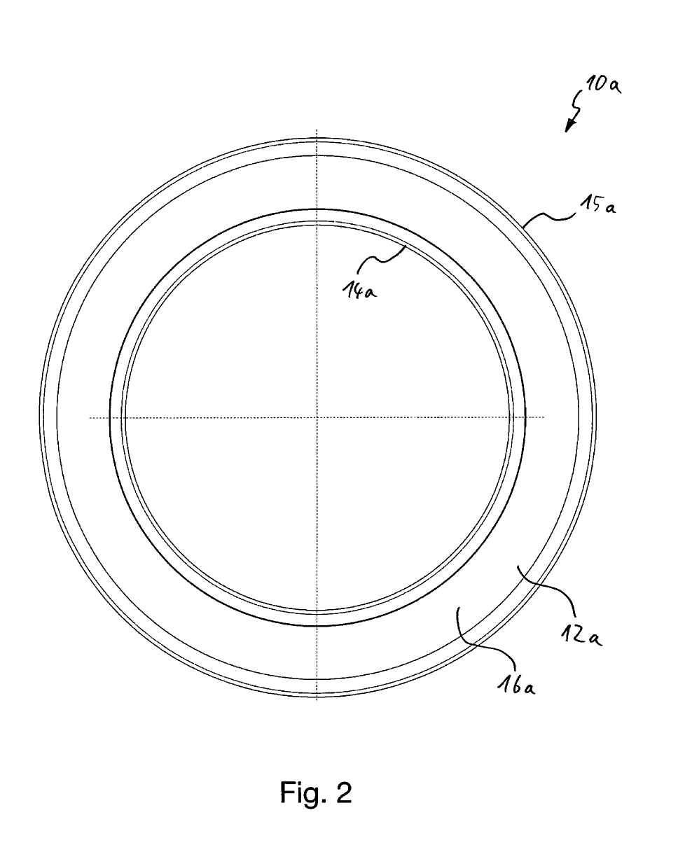

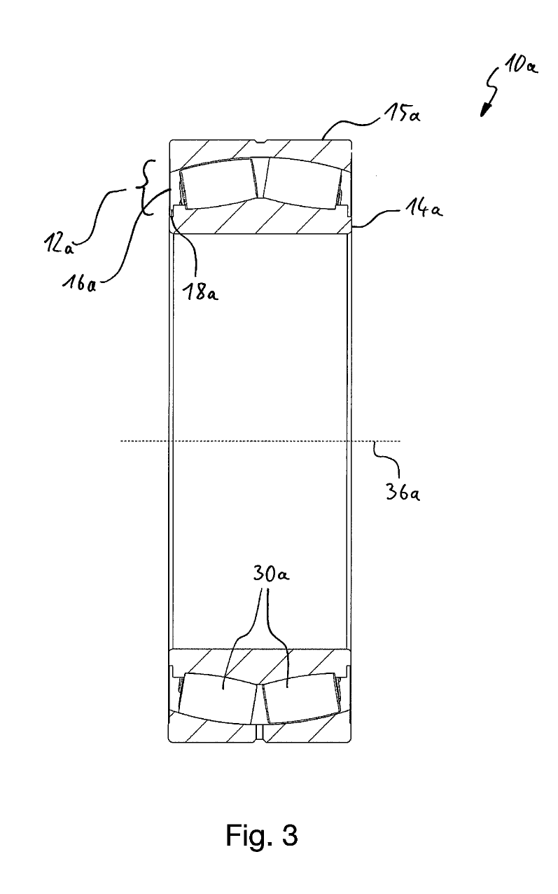

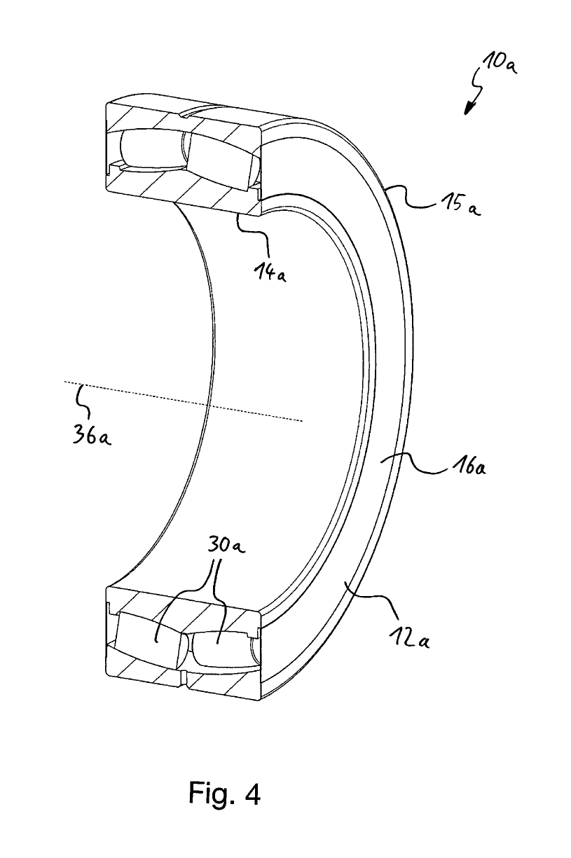

Exemplary embodiments relate to a rolling-element bearing 10a; 10b; 10c; 10d; 10e including a seal unit 12a; 12b; 12c; 12d; 12e. The rolling-element bearing 10a; 10b; 10c; 10d; 10e comprises at least one bearing ring 14a; 14b; 14c; 14d; 14e; 15a; 15b; 15c; 15d; 15e, and the seal unit 12a; 12b; 12c; 12d; 12e comprises an at least part-ring shaped element 16a; 16b; 16c; 16d; 16e attached to the bearing ring 14a; 14b; 14c; 14d; 14e; 15a; 15b; 15c; 15d; 15e. Here the at least part-ring shaped element 16a; 16b; 16c; 16d; 16e delimits a labyrinthine seal gap 18a; 18b; 18c; 18d; 18e. FIGS. 1-4 show a first exemplary embodiment. FIG. 1 shows a detail view of a seal unit 12a in a rolling-element bearing 10a. FIG. 2 shows the rolling-element bearing 10a including the seal unit 12a in overview. FIG. 3 shows a cross-section through the rolling-element bearing 10a including the seal unit 12a in side view. FIG. 4 shows a cross-section through the rolling-element bearing 10a including the seal unit 12a in perspective view. A rolling-element bearing 10a can be partially or completely seen and includes a seal unit 12a. The rolling-element bearing comprises an inner bearing ring 14a, an outer bearing ring 15a, and a plurality of rolling elements 30a in a double row arrangement. In further exemplary embodiments, however, the arrangement of the rolling elements 30a could also differ from these depictions. The seal unit 12a comprises an element 16a which, as can be seen in FIG. 2, is formed as one-part and is ring-shaped.

In further exemplary embodiments, however, a multi-part embodiment could also be possible, for example, an embodiment formed from a plurality of segments which can be assembled into a complete ring. In such a segmented embodiment, the connection of the individual elements or segments could be accomplished by adhering, welding, screwing, clamping, etc. In FIG. 1 it is clear that the element 16a delimits the seal gap 18a on one side. Furthermore, the element 16a is attached to the outer bearing ring 15a such that the element 16a ends flush with the outer bearing ring 15a. For this purpose a recess can be present on the outer bearing ring 15a, into which the element 16a is insertable. The attachment can occur in a friction-fit, materially-bonded, or interference-fit manner. Using such an assembly, for example, the centering of the element 16a could be greatly simplified. In FIGS. 1-4 the seal unit 16a is respectively present on both sides of the rolling elements 30a; for the sake of clarity, however, reference numbers are respectively specified on only one side.

In all five exemplary embodiments, the seal gap 18a; 18b; 18c; 18d; 18e can at least partially extend such that the seal gap 18a; 18b; 18c; 18d; 18e does not extend beyond the bearing ring 14a; 14b; 14c; 14d; 14e; 15a; 15b; 15c; 15d; 15e in the axial direction. In other words, the seal gap can thus be completely located in the “bearing interior,” as can be seen, for example, in FIG. 1. In this way a labyrinthine seal can be realized, and the width of the bearing 10a simultaneously maintained. For example, it can be seen in FIG. 3 that the width of the sealed bearing 10a (i.e. parallel to the central axis 36a) corresponds to the width of the outer bearing ring 15a or of the inner bearing ring 14a.

In the first to fifth exemplary embodiment the element 16a; 16b; 16c; 16d; 16e can be plate-shaped. In FIGS. 1, 3, and 4 such a plate-shaped form of the element 16a is shown, and it can be seen in these figures that the thickness of the element 16a is significantly less than its length and width dimensions.

In the first and third exemplary embodiments (FIGS. 1-4 and 10-21) the seal gap 18a; 18c can additionally be delimited by a recess 20a; 20c in the bearing ring 14a; 14c; 15a; 15c. In the exemplary embodiment shown in FIGS. 1-4 the recess 20a is located on the inner bearing ring 14a. The seal gap 18a is delimited on a further side by this recess 20a. It can further be seen in FIG. 1 that the seal gap 18a extends in the axial direction by more than the thickness of the element 16a. In spherical roller bearings, this configuration allows for a tilting of the inner bearing ring 14a with respect to the outer bearing ring 15a. The surface of the outer bearing ring 15a, which is in contact with the rolling elements 30a, i.e. their raceway, could have the shape of a part of a spherical shell. During a tilting of the inner bearing ring 14a relative to the outer bearing ring 15a, the rolling elements 30a could then be guided along by a profile of the inner bearing ring 14a. In addition, the element 16a could be manufactured from a material which has a high degree of flexibility so that damage resulting from an excessive tilting of the spherical roller bearing could be limited.

In the variant of FIG. 1 there is no direct contact between static and rotating components, and therefore little or no energy loss occurs. Apart from the regular relubrication of the rolling-element bearing 10a, no further maintenance work for maintaining the seal unit 12a may be necessary. In applications requiring long service life, and simultaneously having difficult-to-reach operating locations, such as, for example, offshore wind turbines, this could significantly reduce the cost of maintenance work.

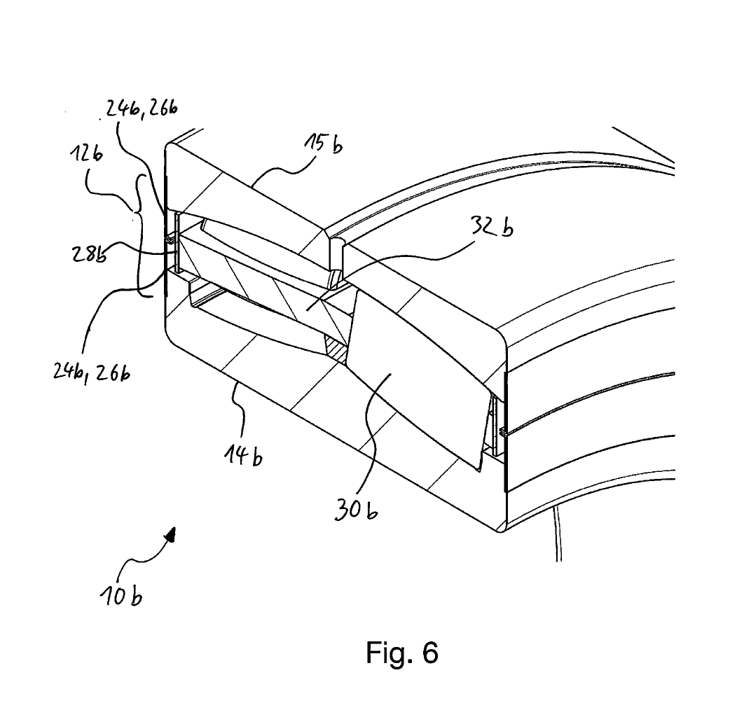

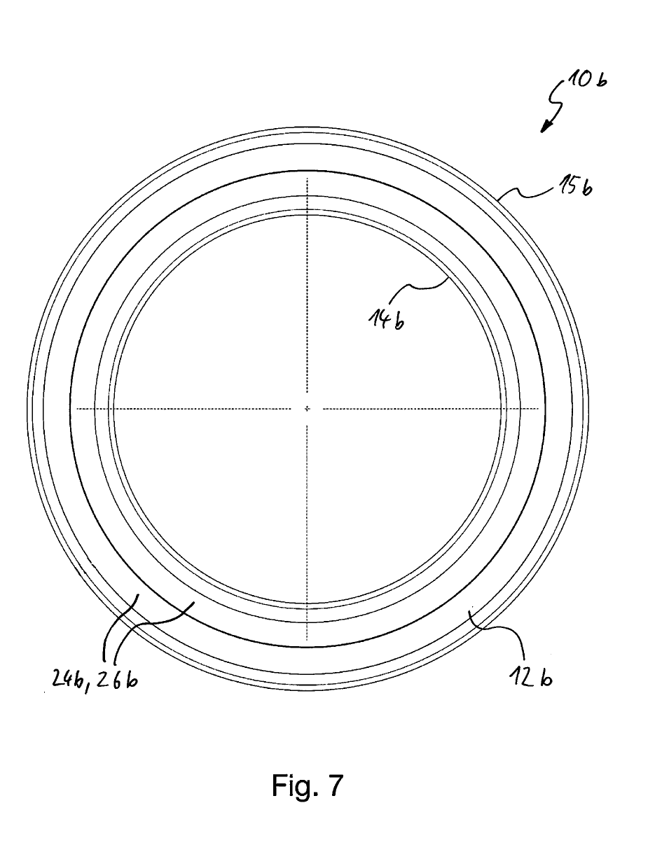

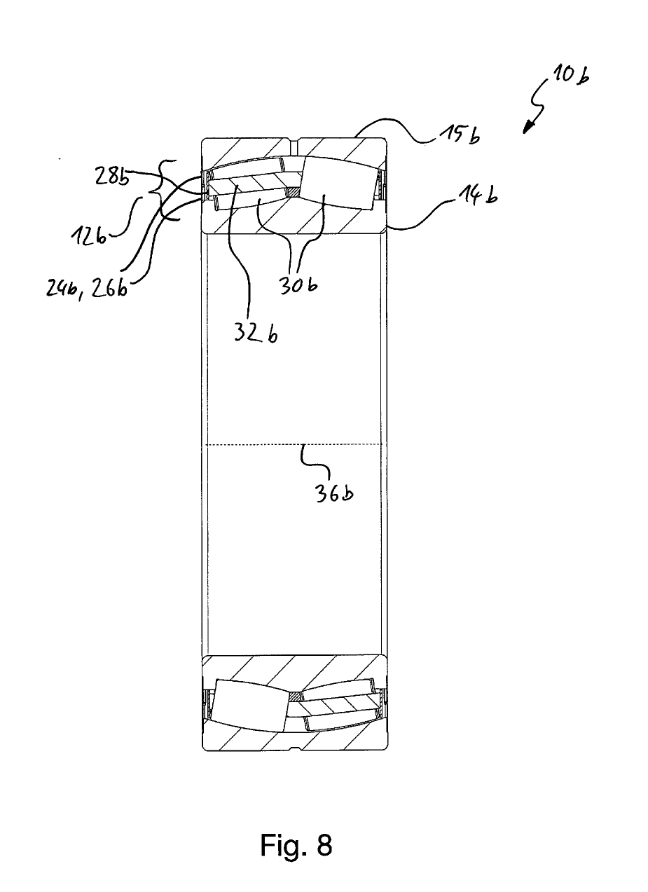

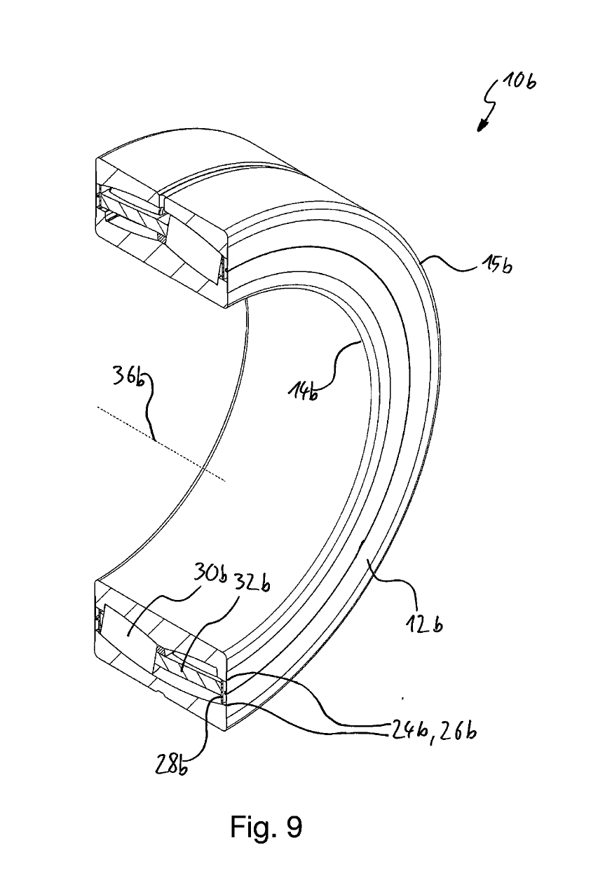

FIGS. 5-9 show a second exemplary embodiment. FIG. 5 shows a detail view of a seal unit 12b in a rolling-element bearing 10b. FIG. 6 shows a further detail view of a seal unit 12b in a rolling-element bearing 10b. FIG. 7 shows a rolling-element bearing 10b including the seal unit 12b in overview. FIG. 8 shows a cross-section through a rolling-element bearing 10b including a seal unit 12b in side view. FIG. 9 shows a cross-section through a rolling-element bearing 10b including the seal unit 12b in perspective view.

In the second to fourth exemplary embodiments, the element 16b; 16c; 16d can have a change of direction 40b; 40c; 40d (an angle or bend) along its course of at least 45°. In addition, in some of these embodiments the element 16b; 16d; 16e can correspond to a first delimiting element 24b; 24d; 24e, and the rolling-element bearing 10b; 10d; 10e can further comprise a second delimiting element 26b; 26d; 26e. In this case, the seal gap 18b; 18d; 18e extends at least partially between the first delimiting element 24b; 24d; 24e and the second delimiting element 26b; 26d; 26e. FIG. 5 shows two delimiting elements 24b and 26b which are respectively attached to the inner bearing ring 14b and to the outer bearing ring 15b. Here both delimiting elements 24b and 26b can correspond to the element 16b. Furthermore, both delimiting elements 24b and 26b can have a change of direction 40b (bend or angle) which is 90° for both in the second exemplary embodiment. The seal gap 18b extends partially between the delimiting elements 24b and 26b. Both delimiting elements 24b and 26b in turn end flush with the respective bearing rings 14b and 15b such that the seal gap 18b does not extend beyond the respectively opposing bearing rings 15b and 14b in the axial direction. Furthermore, the seal gap 18b is located in the center between the bearing rings 14b and 15b, which makes an undesired escape of lubricant more difficult.

In some exemplary embodiments the rolling-element bearing 10b includes a third delimiting element 28b attached to a bearing cage 32b. In these embodiments, part of the seal gap 18b extends between the first delimiting element 24b and the second delimiting element 26b, and part extends between the second delimiting element 26b and the third delimiting element 28b. In FIG. 5 the part of the seal gap extends between the delimiting elements 24b and 26b, and a further part extends between the third element 28b and one of the delimiting elements 24b and 26b. Since the seal gap is at least approximately central in its section between the elements 24b and 26b, the path that a penetrating dirt particle would have to follow is lengthened. The shape of the seal gap thus makes it more difficult for dirt to penetrate into the rolling-element bearing 10b. The third delimiting element 28b is also attached to a bearing cage 32b, which attachment can occur in a friction-fit, materially-bonded, or interference-fit manner. Furthermore, using this arrangement a collision of the rolling elements with one of the delimiting elements 24b; 26b or 28b can be avoided in the event of a tilting or axial movement of the inner bearing ring 14b with respect to the outer bearing ring 15b. In FIG. 8 and FIG. 9 a dashed line marks the central axis 36b which is simultaneously the axis of rotation in the non-tilted state of the bearing 10b. The central axis 36b extends through the intersection of two dashed lines in FIG. 7.

In self-centering bearings, for example, spherical roller bearings, or compact aligning roller bearing (CARB) toroidal roller bearings, or axially displaceable rolling-element bearings such as cylindrical roller bearings, the penetration of contaminants could also be made more difficult by the bending (i.e. the change of direction 40b) of the delimiting elements 24b and 26b (second exemplary embodiment) towards the seal gap 18b. The degree of slanting is selectable based on the expected tilting or displacing of the inner ring 14b with respect to the outer ring 15b.

Selecting an appropriate configuration of the seal gap 18a; 18b in the first and second exemplary embodiment helps ensure the required angular mobility with CARB toroidal or spherical roller bearings. In non-self-centering rolling-element bearings 10a; 10b a narrow seal gap 18a; 18b can be used in order to achieve an increased sealing function.

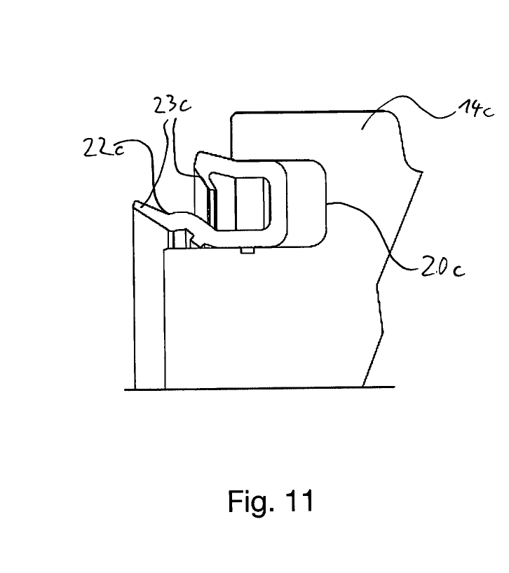

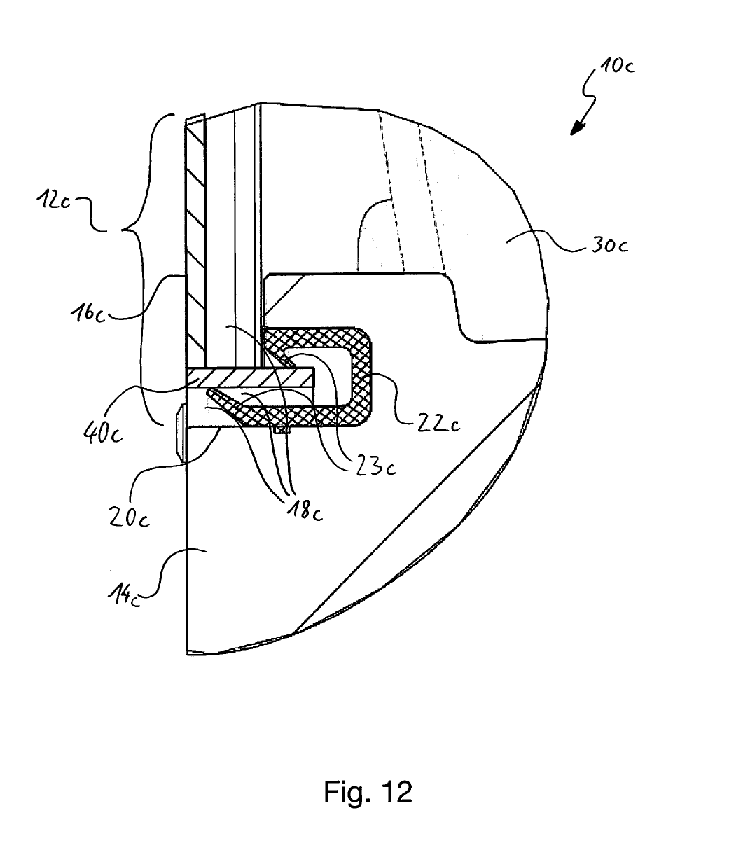

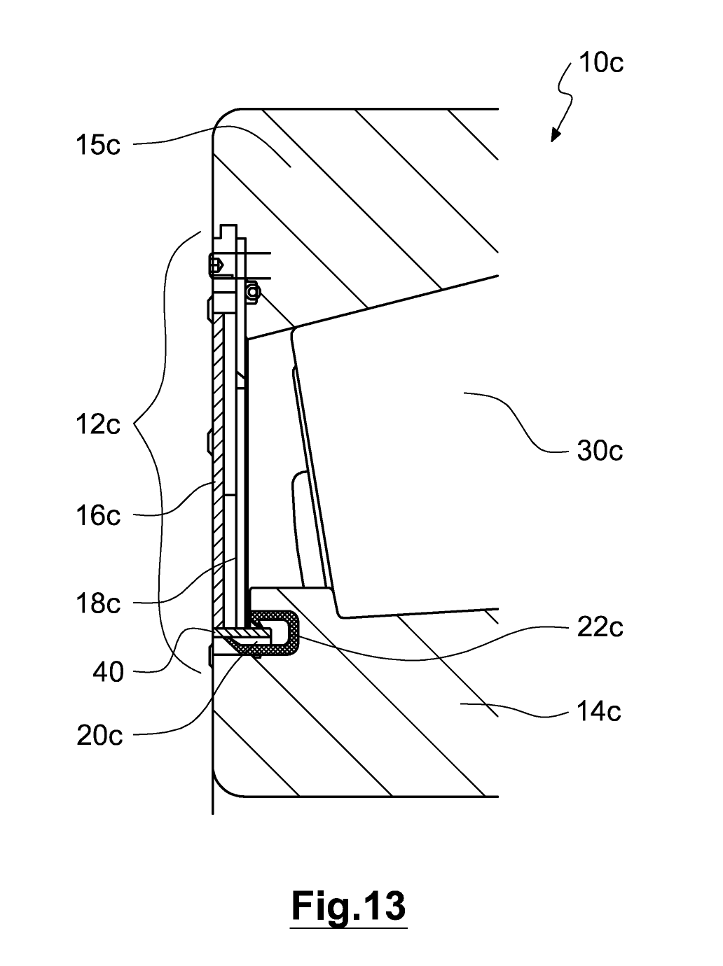

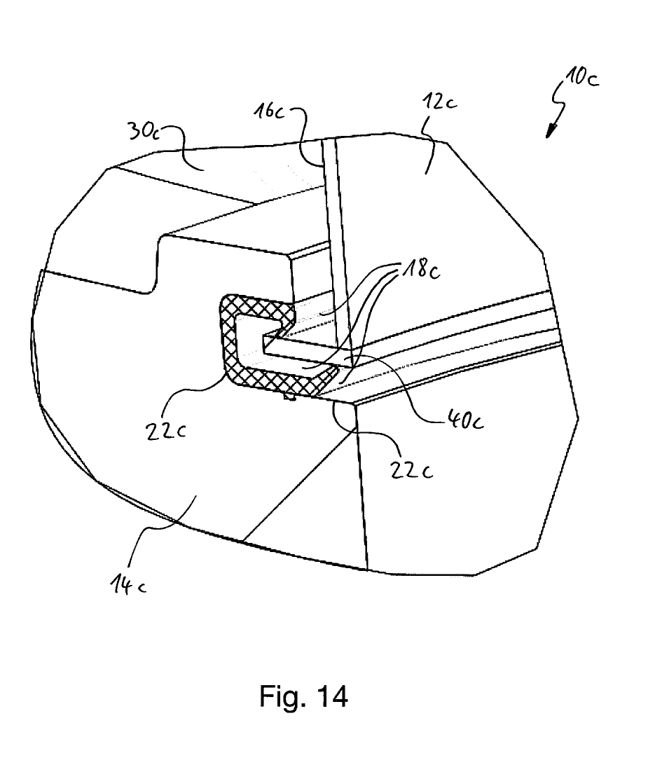

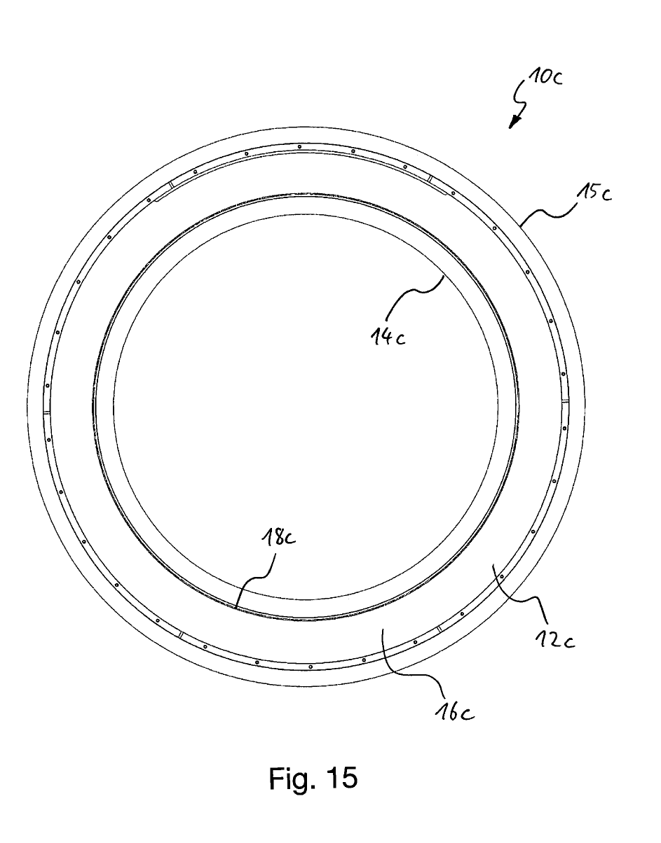

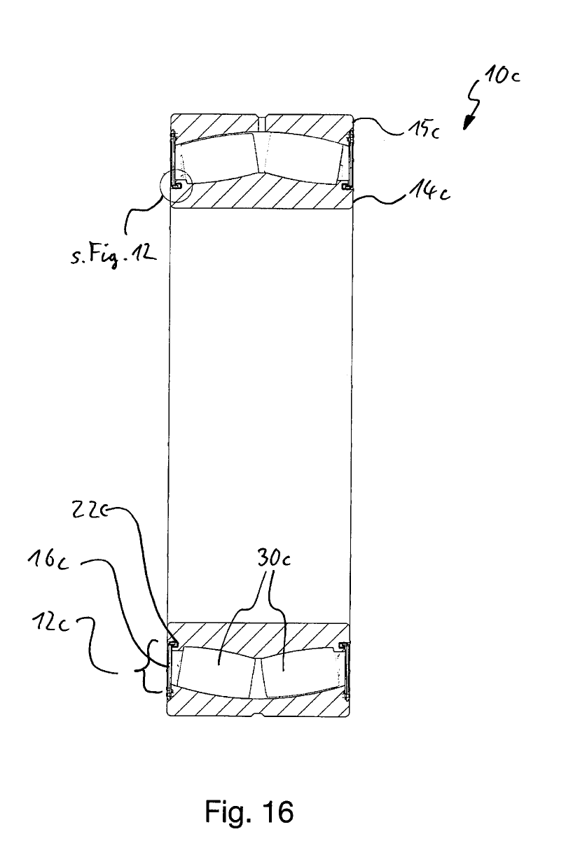

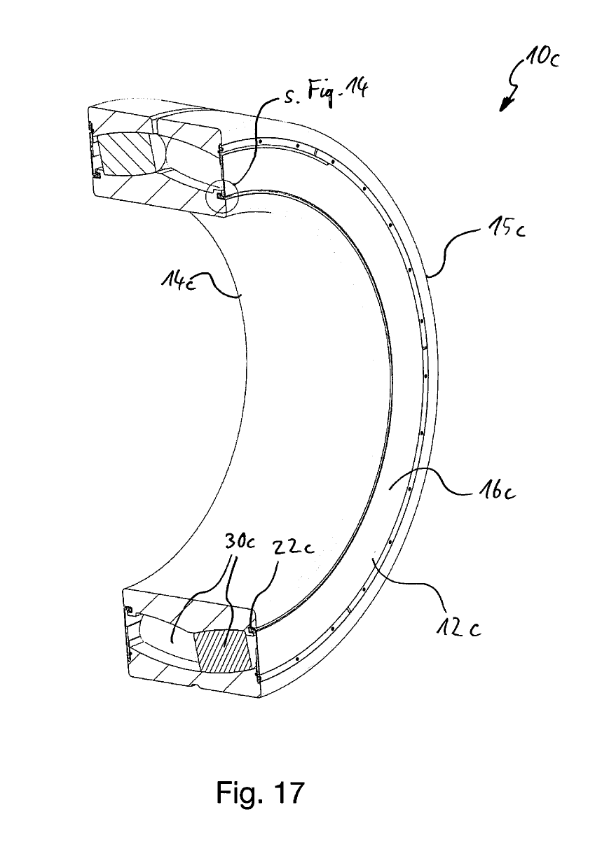

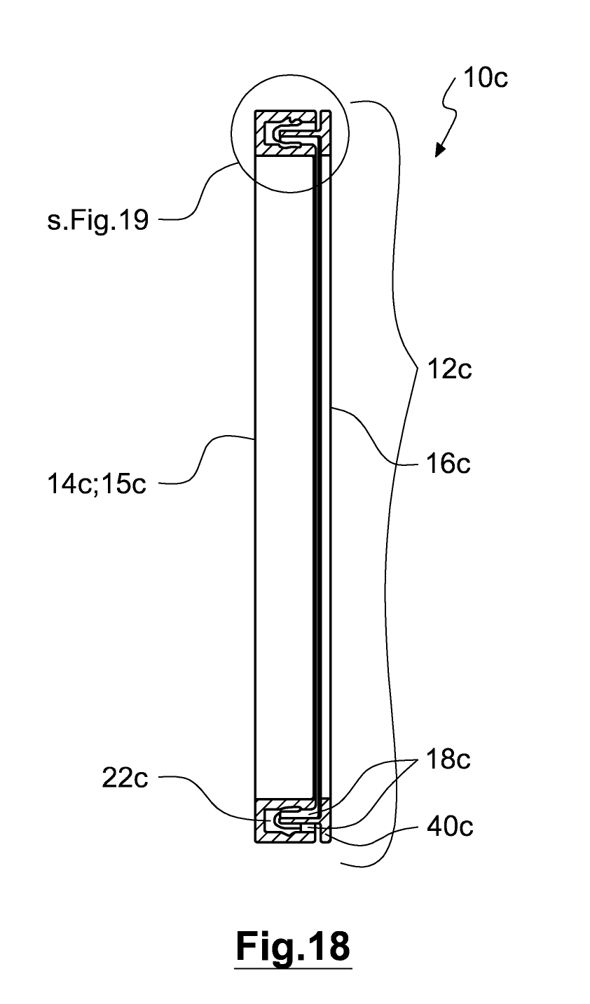

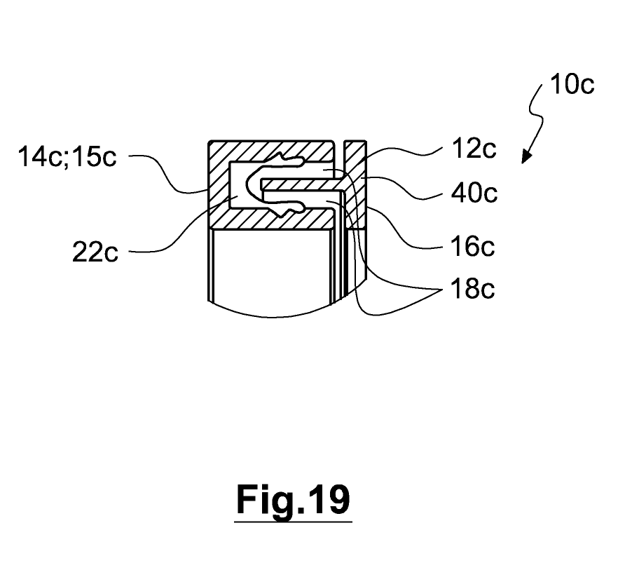

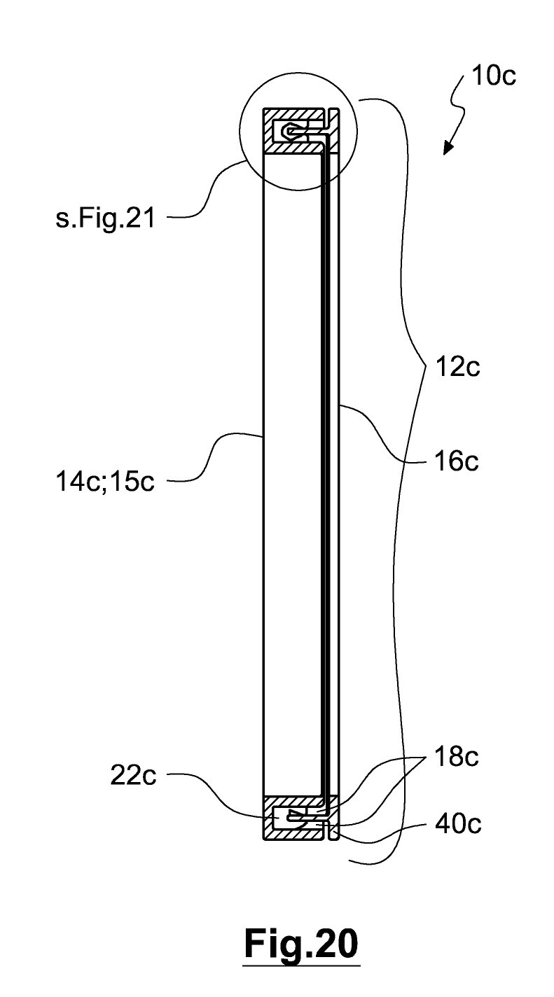

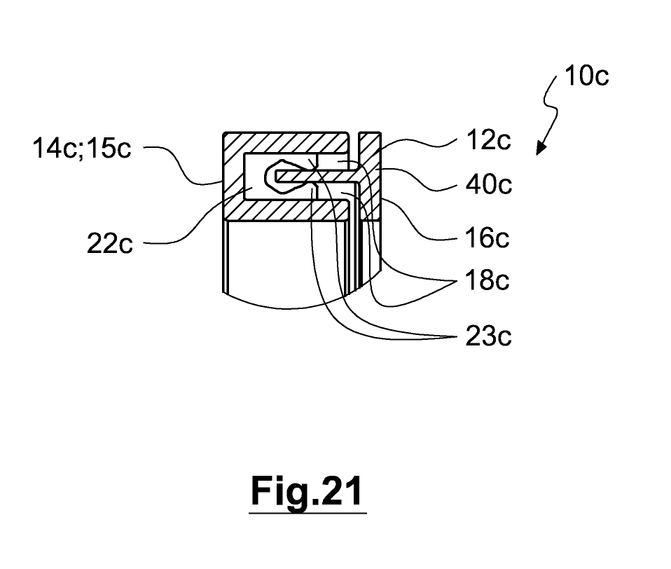

FIGS. 10-21 show a third exemplary embodiment. FIG. 10 shows a seal lip 22c. FIG. 11 shows an installation of the seal lip 22c. FIG. 12 shows a detail view of a seal unit 12c including the seal lip 22c in a rolling-element bearing 10c. FIG. 13 shows a further detail view of the seal unit 12c in the rolling-element bearing 10c. FIG. 14 shows a still further detail view of the seal unit 12c in the rolling-element bearing 10c. FIG. 15 shows the rolling-element bearing 10c including the seal unit 12c in overview. FIG. 16 shows a cross-section through the rolling-element bearing 10c including the seal unit 12c in side view. FIG. 17 shows a cross section through the rolling-element bearing 10c including the seal unit 12c in perspective view. FIG. 18 shows a further variant of the seal unit 12c. FIG. 19 shows the further variant of the seal unit 12c in detail view. FIG. 20 shows a still further variant of the seal unit 12c. FIG. 21 shows the still further variant of the seal unit 12c in detail view.

The third exemplary embodiment shown in FIGS. 10-21 comprises a seal unit 12c for a rolling-element bearing 10c (e.g. large bearing) that includes a stationary element 16c (here identified as a labyrinth ring), mounted for example on the outer ring 15c, and a rotating seal lip 22c (extruded or turned elastomer element) in a groove 20c, for example, mounted in the inner ring 14c so that the seal lip 22c contacts the stationary element 16c. In an exemplary embodiment both parts can be installable independently of one another, and this may simplify installation, maintenance, and replacement of the seal unit 12c and the monitoring of the bearing 10c. Installing the seal unit 12c in the bearing 10c with the lowest possible distance to the center of rotation of the bearing 10c, helps ensure an increased angular mobility of the sealed bearing 10c (up to a few degrees) or a large axial displaceability. Due to the design of the seal lip 22c, a through-flow of lubricant from the interior of the bearing 10c outward could also be possible. In some exemplary embodiments the seal lip 22c is deformable during insertion into the groove 20c in the inner ring 14c to such an extent that the seal surface(s) 23c of the seal lip 22c abut on the countersurface (labyrinth ring) with a defined strength (pressure), and thereby both seal well and have enough flexibility to provide a desired an angular mobility of the bearing 10c. Both the seal lip 22c and the element 16c are cost-effective wear parts that are easily replaceable, and their use can help avoid or reduce the need to remove the entire bearing 10c or avoid the need for any post-processing of special countersurfaces for the seal (e.g. use of a so-called wear sleeve, i.e. a sleeve which is additionally mounted on a wear surface so that the wear and tear on the wear surface is reduced).

As FIG. 10 shows, the seal lip 22c can be formed in one-piece. Furthermore, the seal lip 22c can include at least two seal surfaces 23c which are disposed on mutually facing side surfaces of the seal lip 22c. The seal lip 22c shown in FIG. 10 can, for example, be an extruded or turned profile. Extruded profiles allow for the use of the same profile for different diameters or for replacement or for repair. In some exemplary embodiments the geometry of the seal lip 22c can be open in the uninstalled state, i.e. the actual seal surfaces 23c can be “spread.”

Referring now to FIG. 11, if the seal 22c is pushed into the recess 20c (here formed as a groove) of the bearing inner ring 14c, the seal surfaces 23c can “close.” In other words, a spacing between the two seal surfaces 23c is reduced by inserting the seal 22c into the recess 20c. The spacing reduction can occur such that, with a threading of a labyrinth ring (e.g. element 16c), the seal surfaces 23c exert a contact pressure on a respective side surface of the element 16c, and the side surfaces of the element 16c can face away from each other. Furthermore, a labyrinth gap is delimited by the seal lip 22c and by the element 16c (FIG. 19). In its course between the two seal surfaces 23c, the labyrinth gap has a change of direction of 180° in total, and a region of the labyrinth gap is respectively sealed inward and outward by the seal surfaces 23c. (The term “inward” refers to a space enclosed by the bearing 10c which also comprises the rolling elements.) The seal surfaces 23c are supported in sliding contact with the element 16c. Furthermore, the seal surfaces 23c are inclined such that their contact points with the element 16c point outward, or in other words, point in a direction which follows a course of the labyrinth gap away from the rolling elements. In this way the penetration of contaminants or moisture in a counter-direction (inward) opposing the direction can be further made more difficult. During a later threading of the labyrinth ring, i.e. of the element 16c, in the axial direction, the seal surfaces 23c can abut on the countersurface in a previously defined direction, and seal in this manner (see FIG. 12). The seal surfaces 23c can be designed such that the penetration of contaminants from outside is made more difficult, but an opening outward is possible (e.g. due to high pressure, so that, for example, excess lubricant can be discharged, e.g. during relubrication.) Here the seal lip 22c can be mounted before the element 16c.

In the first and third exemplary embodiment, the bearing ring 14a; 14c; 15a; 15c can include a seal lip 22a; 22c in abutment with the element 16a; 16c. Possible embodiments are shown in the third exemplary embodiment, in different variants, in FIGS. 12 to 21.

FIGS. 13 to 17 show a first variant of the third exemplary embodiment. The element 16c, here formed in an L-shape, is attached to the outer ring 15c of the bearing 10c. In the embodiment of FIGS. 13 and 14 the element 16c is clamped in a groove in the outer ring 15c. However, other friction-fit, interference-fit, or materially-bonding methods could also be used for attaching the element 16c. In FIG. 15 it can be seen that the element 16c is annular. As in previous exemplary embodiments, it is possible to construct the element 16c, in a part-ring shaped manner, i.e., for example, segmentally. In some exemplary embodiments the element 16c is solid, i.e. a turned part made from cast iron or steel, or even a welded structure, to name only a few examples. The countersurface to the seal lip 22c (the short leg) could offer a good countersurface for the seal lip 22c with low surface roughness and form tolerances. Due to the locking of the element 16c in the outer ring 15c, a good centering with respect to the inner ring 14c, and thus a high running accuracy, could be effected.

In addition, it can be seen in FIGS. 13 and 14 that a clearance is present between the seal lip 22c and the element 16c, so that tilting or axial movements are possible. The seal unit 12c could also be used in spherical roller bearings, as shown, for example, in FIGS. 16 and 17.

FIGS. 18 and 19 show a further variant of a seal unit 12c according to the third exemplary embodiment. A circle in FIG. 18 marks an image detail which is depicted again enlarged in FIG. 19. The element 16c in turn has a change of direction 40c. As in the previous variant the change of direction is also 90°. Furthermore, the element in FIGS. 18 and 19 is T-shaped, such that the labyrinthine seal gap 18c undergoes an additional change of direction and potentially increases the sealing effect. The bearing ring 14c, 15c shown in FIGS. 18 and 19 can be an inner bearing ring as well as an outer bearing ring. Sufficient clearance is present between the element 16c and the seal lip 22c to also make the seal unit 12c usable, for example, in spherical roller bearings or with axial displacement of the bearing 10c.

FIGS. 20 and 21 show a still further variant of a seal unit 12c according to the third exemplary embodiment. An image detail marked with a circle in FIG. 20 is depicted enlarged in FIG. 21. As in the previous variants, the element 16c is T-shaped. The seal lip 22c has two seal surfaces 23c which extend to an acute angle on the short leg of the element 16c. The two contact angles are disposed such that a penetration of substances along the labyrinthine seal gap 18c past the seal lip 22c is made significantly more difficult. In other words, the escape of lubricant as well as the penetration of contaminants or moisture can be prevented. In comparison thereto, for example, FIG. 13 shows a seal lip 22c which could make possible a regulated, controlled outflow of excessive lubricant due to the arrangement of its seal surfaces 23c. Furthermore, in the arrangement shown in FIG. 21 the seal surfaces 23c of the seal lip 22c are oriented such that their clamping effect, and thus the sealing on the leg of the element 16c, could be strengthened by appropriate contact pressure of the element 16c. In other words, the seal lip 22c is designed such that the seal surfaces 23c move towards each other if the leg of the element 16c presses on the inner region of the seal lip 22c between the seal surfaces 23c.

Due to the integration of the seal unit 12c in the bearing 10c, the ISO installation space could be maintained. The seal unit 12c further allows a high angular and axial mobility of the bearing 10c. With wear and associated exchange (replacement) of the seal unit 12c, removal of the bearing 10c may not be necessary, which, for example, could be relevant in wind power applications. In addition, the releasable connection of the seal unit 12c could allow for a relubrication of the bearing 10c.

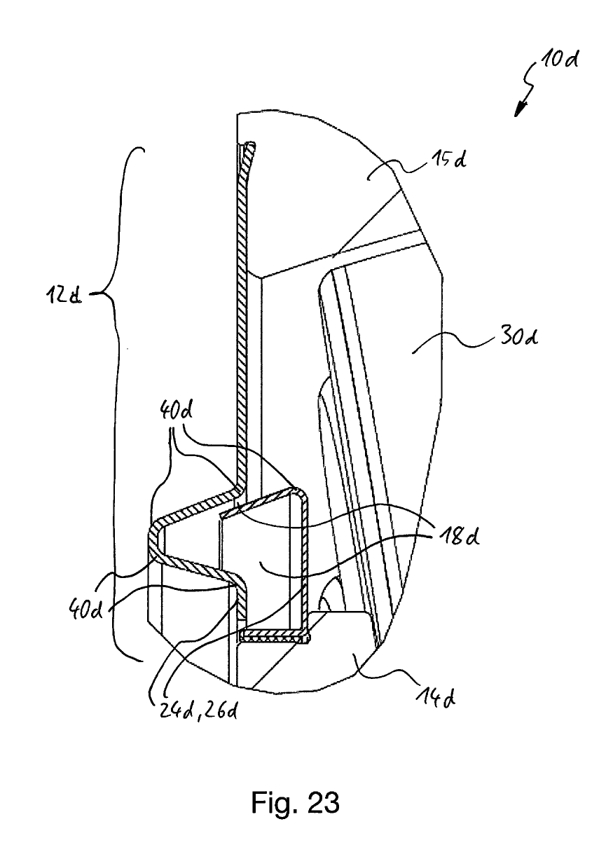

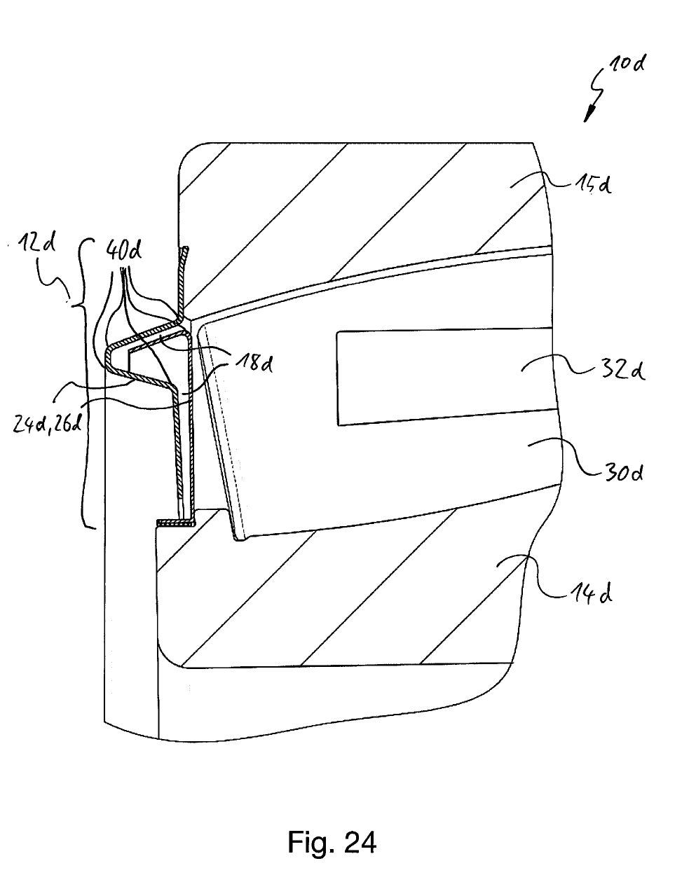

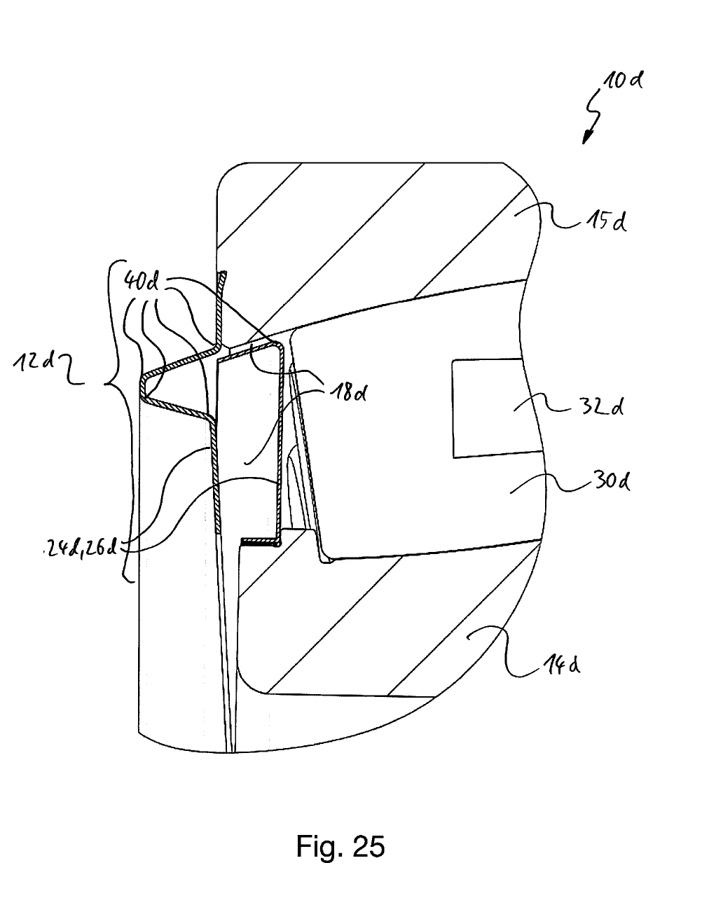

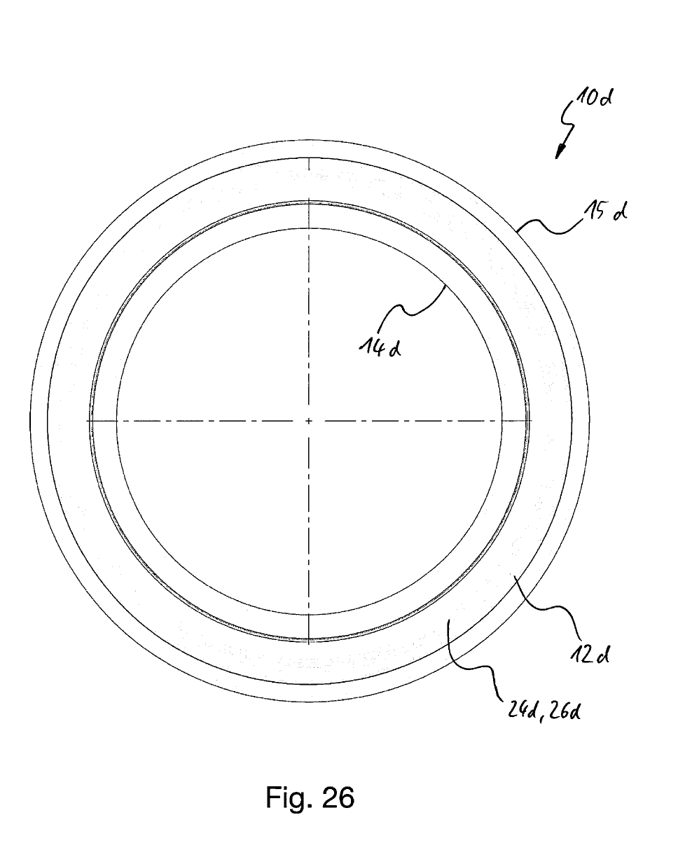

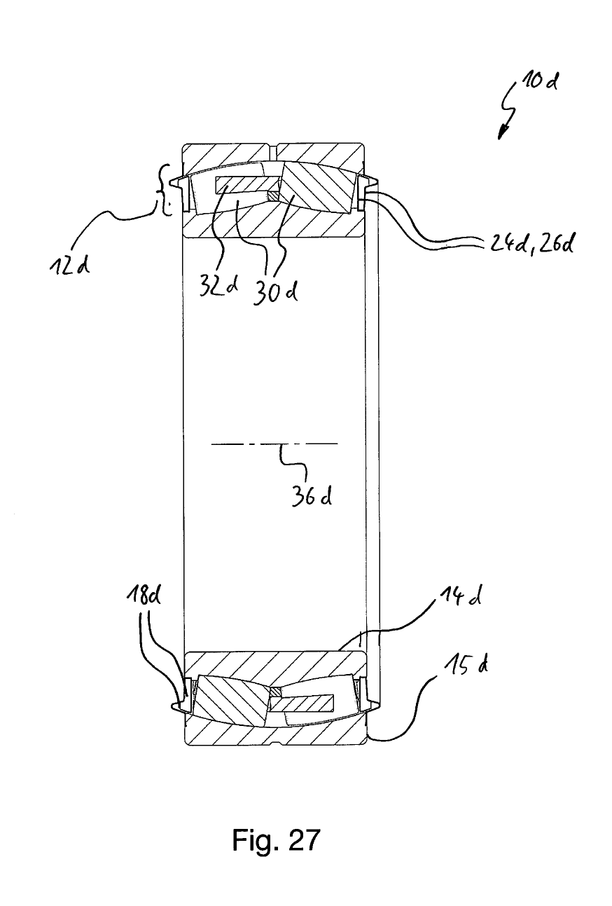

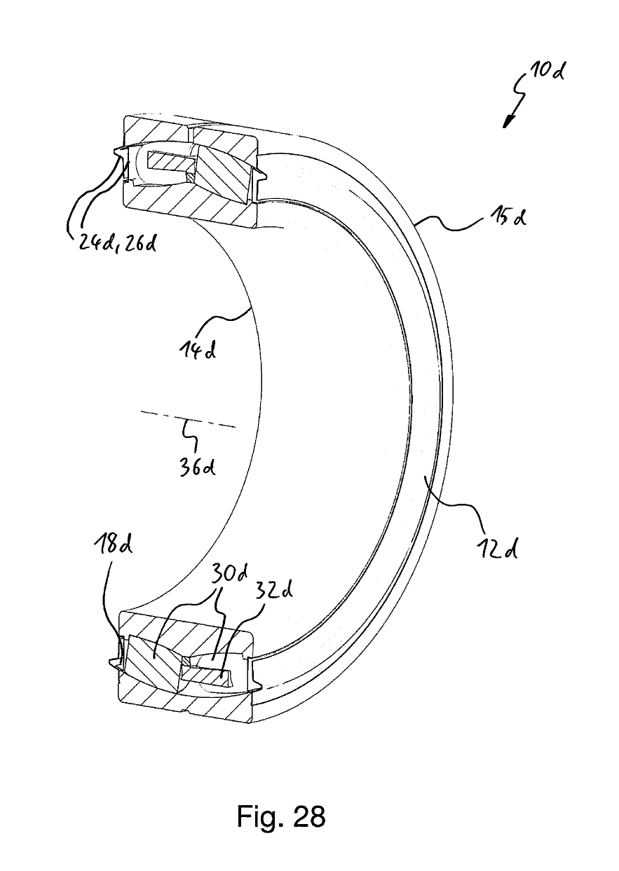

FIGS. 22-28 show a fourth exemplary embodiment. FIG. 22 shows a detail view of a seal unit 12d in a rolling-element bearing 10d. FIG. 23 shows a further detail view of the seal unit 12d in the rolling-element bearing 10d. FIG. 24 shows an example of the seal unit 12d in a spherical roller bearing. FIG. 25 shows a further example of the seal unit 12d in a spherical roller bearing. FIG. 26 shows the rolling-element bearing 10d including the seal unit 12d in overview. FIG. 27 shows a cross-section through the rolling-element bearing 10d including the seal unit 12d in side view. FIG. 28 shows a cross-section through the rolling-element bearing 10d including the seal unit 12d in perspective view.

The fourth exemplary embodiment shown in FIGS. 22-28 is a seal unit 12d for a bearing 10d, e.g. a self-aligning large bearing with reduced friction. The delimiting elements 24d; 26d are disposed in a labyrinthine manner and could help protect against contamination of the rolling-element bearing 10d. The variants shown could lead to a friction-optimized, improved, or low-wear or even wear-free operation. Here in operation a tilting of more than +/−0.5° (depending on geometry) and an axial displaceability in angularly and axially displaceable rolling-element bearings 10d such as spherical roller bearings or CARB toroidal roller bearings could be accommodated using the foregoing embodiment of the delimiting elements 24d; 26d by appropriate choice of the spacings and geometries themselves.

FIG. 22 shows a seal unit 12d in which the element 16d corresponds to a first delimiting element 24d. Furthermore, the seal gap 18d is delimited by a second delimiting element 26d. The delimiting elements 24d and 26d here can both correspond to the element 16d; the terms “first delimiting element” and “second delimiting element” are thus interchangeable. Here one of the delimiting elements 24d; 26d has a plurality of changes of direction 40d (bends or curves or angles). A V-shaped bulge thereby results. The corresponding other delimiting element 26d; 24d also has a change of direction 40d, so that the delimiting element 26d; 24d ends in an angled leg. This leg protrudes in the axial direction into the V-shaped recess of the other delimiting element 24d; 26d. In this way the labyrinthine seal gap 18d undergoes a plurality of changes of direction, which can produce a greatly increased sealing effect. The delimiting element 26d; 24d attached to the bearing inner ring 14d is thus located closer to the rolling elements 30d than the other delimiting element 24d; 26d which is attached to the bearing outer ring 15d. In this way collisions of the rolling elements 30d with one of the delimiting elements 24d or 26d can be avoided.

FIG. 23 shows a further variant of the fourth exemplary embodiment, wherein the V-shaped bulge of the delimiting element 24d; 26d lies closer to the inner bearing ring 14d than is the case in FIG. 22. FIGS. 24 and 25 show the seal unit 12d in a spherical roller bearing 10d in which the inner bearing ring 14d is respectively tilted in two different directions with respect to the outer bearing ring 15d. In this way it is clear that the seal gap 18d allows tilting or axial movements due to its width, and this may open a wide spectrum of use possibilities for the seal unit 12d. FIG. 26 shows the spherical roller bearing 10d including the seal unit 12 in overview.

FIGS. 27 and 28 show the spherical roller bearing 10d including the seal unit 12d again in untilted state. A dashed line marks the central axis 36d of the bearing 10b and is simultaneously its axis of rotation.

As depicted in FIG. 22, the delimiting elements 24d and 26d have a geometrically complex configuration in order to enable any necessary angular mobility. The delimiting element 24d; 26d oriented towards the environment reaches close to the inner ring 14d. This helps prevent dirt particles in the “6 o'clock” position (i.e. in a low region of a bearing 10d when operated with a horizontally oriented axis of rotation) from falling into the seal gap 18d and being pumped to the bearing interior.

The delimiting elements 24d and 26d can be folded for installation and positioning purposes. FIG. 22 shows, for example, that the delimiting element 24d; 26d mounted on the outer ring 15d is folded by a few degrees, for example, and is inserted (caulked) in a groove formed in the outer ring 15d. In contrast, the delimiting element 26d; 24d attached to the inner ring 14d is folded by 90° so that its installation can be accomplished, for example, by adhering, clamping, press-fitting or the like. A rubber coating is also possible, for example, so that the delimiting element 26d; 24d can be pushed on and centered in a simple manner.

Both delimiting elements 24d and 26d can be centered in the recesses and attached by screwing, adhering, clamping or the like. According to the geometry chosen, a narrower seal gap 18d can be formed between the delimiting elements 24d and 26d near the outer ring such that a tilting between inner ring 14d and outer ring 15d is possible in spherical roller bearings such as the ones illustrated herein. In addition, the position of the seal gap 18d could be variable—closer to the outer ring 15d or inner ring 14d—depending on the geometry, environmental conditions, required tilting, etc.

In the exemplary embodiment of FIGS. 22-28, by mounting the farther-inward-lying delimiting element 26d; 24d on the inner ring, the delimiting element 26d; 24d is carried along when the inner ring and outer ring tilt. In this embodiment the spacing of this delimiting element 26d; 24d and the rolling elements 30d is constant. The maximum tilting can be determined by the chosen geometry of the delimiting elements 24d and 26d. The ISO external dimensions of the rolling-element bearing 10d could thus be maintained with the seal variant chosen. The delimiting elements 24d; 26d themselves extend beyond the dimensions of the bearing 10d and can thus help provide for an increase in angular displaceability.

A fifth exemplary embodiment shown in FIGS. 29-35 describes a further seal unit 12e for a bearing 10e, e.g., a self-centering large bearing. The delimiting elements 24e and 26e disposed in a labyrinthine manner could offer, in three different embodiment variations, an additional protection against contamination of the rolling-element bearing 10e, especially in demanding uses such as wind turbines. Similarly, Z-shaped ribs (lamellae) for smaller rolling-element bearings could allow for reduced friction or low-wear, or wear-free, operation of the variants shown. Using an appropriate choice of spacing of the delimiting elements 24e; 26e in self-centering or axially-displaceable rolling-element bearings such as spherical roller bearings or CARB toroidal roller bearings, in operation a tilting of up to +/−0.5° and an axial displaceability could be possible.

FIG. 29 shows a detail view of a seal unit 12e in a rolling-element bearing 10e. The element 16e corresponds to a first delimiting element 24e. The labyrinthine seal gap 18e is further delimited by a second delimiting element 26e. The delimiting elements 24e and 26e can both correspond to the element 16d; the terms “first delimiting element” and “second delimiting element” are thus interchangeable. The two elements 24e and 26e have a very large overlap in the radial direction. A delimiting element 24e and 26e is respectively attached to the inner bearing ring 14e and the outer bearing ring 15e. Between the delimiting elements 24e or 26e and the respectively opposing bearing ring 15e or 14e a section of the labyrinthine seal gap 18e remains open, and this section has a smaller extension in the radial direction as compared to the radial extension of one of the delimiting elements 24e, 26e. In this way the length of the seal gap 18e can be increased or even maximized and the sealing effect could thereby increase. Due to the width of the seal gap 18e, axial displacements of the bearing, or tilting of the two bearing rings 14e and 15e with respect to each other (spherical roller bearing) are possible.

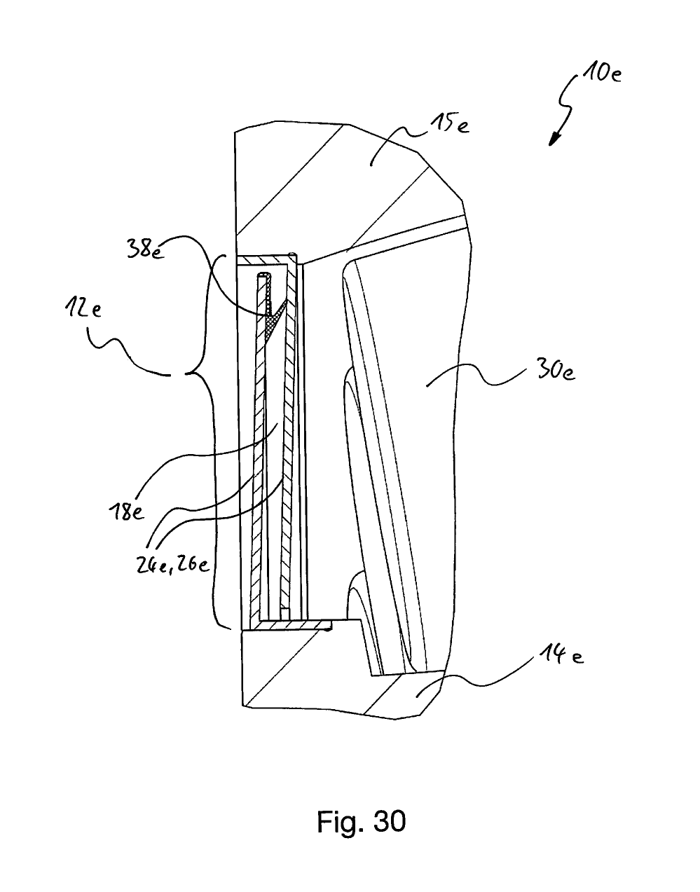

In the five exemplary embodiments presented, the seal gap 18a; 18b; 18c; 18d; 18e can additionally include a flocking 34e and/or a seal lip 22e; 38e. As illustrated in FIG. 30, for example, in some exemplary embodiments the seal lip 38e can be formed at an angle which makes possible a controlled outflow of excess lubricant, but that could make the penetration of contaminants more difficult. Both the seal lip 38e and the flocking 34e can be located on a side of the first delimiting element 24e or of the second delimiting element 26e, which side delimits the seal gap.

In FIG. 29 the delimiting elements 24e and 26e are folded for installation and positioning purposes, and a corresponding recess can be provided respectively on the outer ring 15e and inner ring 14e of the rolling-element bearing 10e, so that the fold of the delimiting elements 24e and 26e is located here. The two delimiting elements 24e and 26e can each be centerable in the recesses and fixable, e.g., by screwing, adhering, clamping, or the like. Between the delimiting elements 24e and 26e, which can be disposed plane-parallel with respect to each other, a narrow seal gap 18e is thus formed. This seal gap 18e can be dimensioned such that a desired tilting between inner ring 14e and outer ring 15e is still possible in the case of the spherical roller bearing shown here.

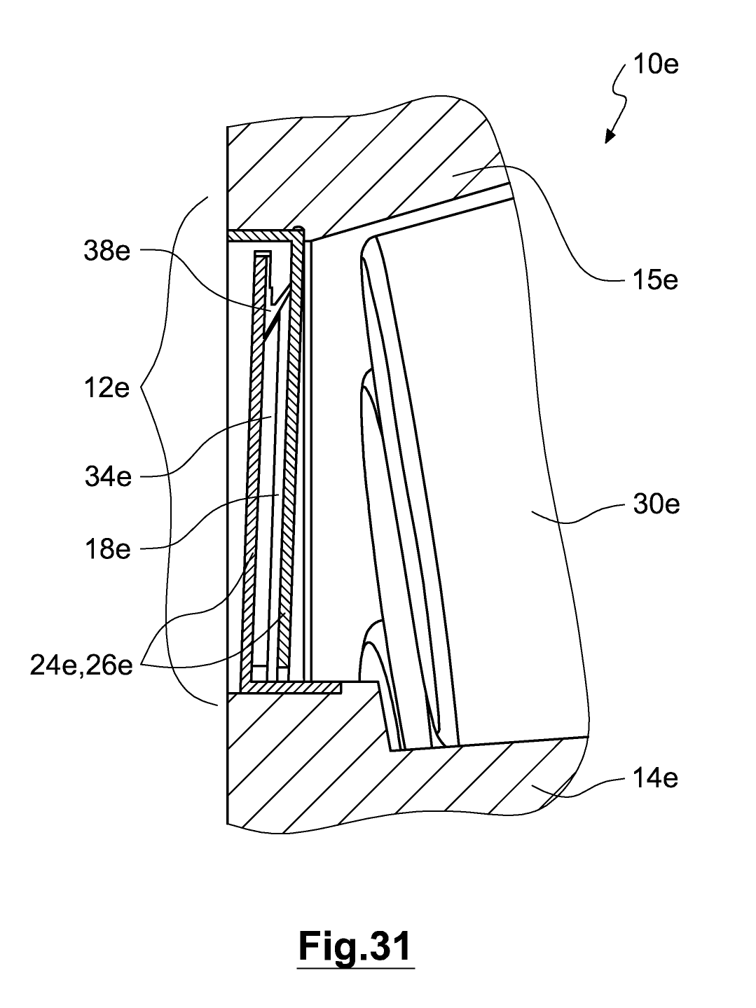

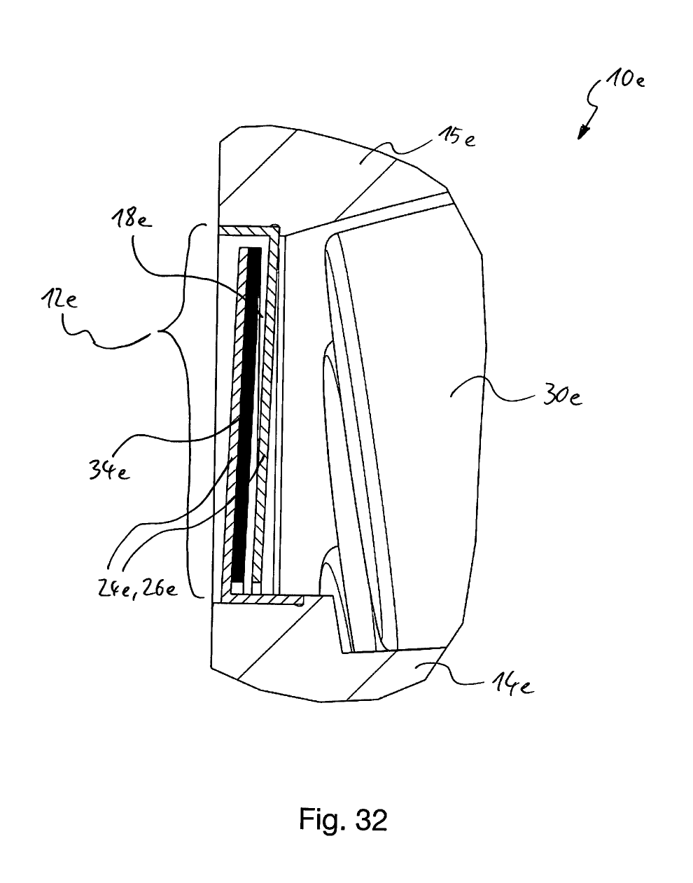

FIG. 30 is a detail view of a seal unit 12e including a seal lip 38e in a rolling-element bearing. The seal lip 38e is connected to one of the delimiting elements 24e; 26e and is in sliding contact with the respective other delimiting element 26e; 24e. The seal lip 38e provides a more effective seal, and can be adhered, vulcanized or the like and can thus be embodiable such that a tilting is made possible in self-aligning bearings 10e. Due to the orientation shown in FIG. 30, a lubricant flow from the bearing interior towards the environment is possible, as is a relubricating of the rolling-element bearing 10e. Simultaneously, dirt accumulating from the environment can be inhibited from penetrating into the bearing interior. FIG. 31 shows a detail view of the seal unit 12e including the seal lip 38e and flocking 34e in the rolling-element bearing 10e, which constitutes a further expansion/extension variant. Here in addition to the attached seal lip 38a, flocking 34e is also introduced in the intervening space between outer and inner delimiting elements 24e and 26e. An additional protection of the bearing interior can thereby be achieved. The flocking 34e could, on one hand, increase resistance to foreign particles which could possibly reach the bearing interior via the seal gap. On the other hand, lubricant could be retained in this region in an enhanced manner and form an additional barrier. FIG. 32 shows a detail view of the seal unit 12e only including flocking 34e in the rolling-element bearing 10e, as is also feasible.

Since in the variant shown in FIG. 29 there is no direct contact between static and rotating components, little or no energy loss occurs. No further maintenance work for maintaining the seal unit 12e may be necessary apart from the regular relubrication of the rolling-element bearing 10e. In applications requiring long service life, and simultaneously having difficult-to-reach operating locations, such as, for example, offshore wind turbines, this could lead to significant cost savings in maintenance work. In the variants shown in FIGS. 30-32, the sealing effect of the labyrinth can be additionally increased.

Depending on the choice of the seal gap 18e between the delimiting elements 24e and 26e, the required angular and axial mobility, e.g. in CARB toroidal or spherical roller bearings could be ensured while maintaining the ISO installation space. In non-self-aligning rolling-element bearings a narrow seal gap 18e can be provided in order to achieve an increased sealing function.

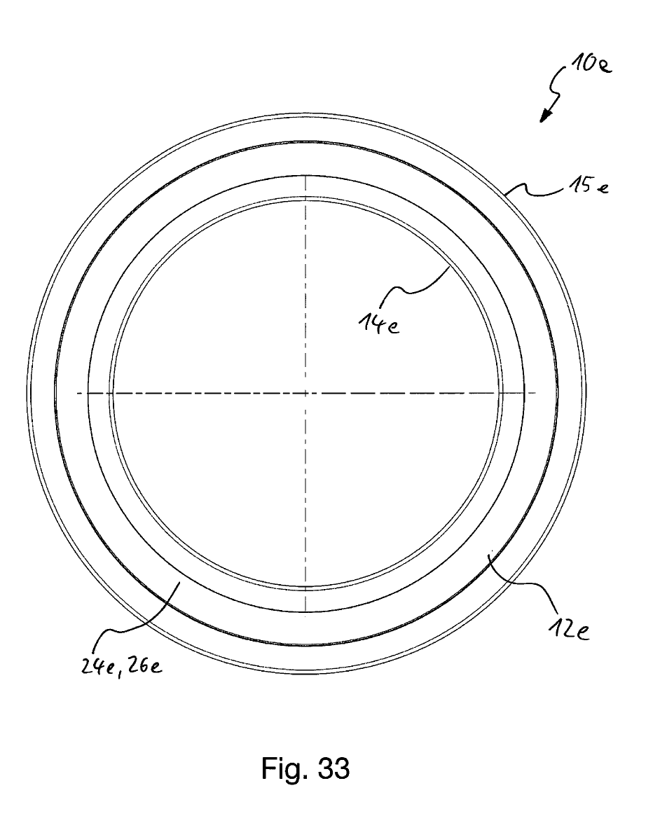

Further, different view perspectives of the seal unit 12e in the rolling-element bearing 10e are shown in FIGS. 33-35.

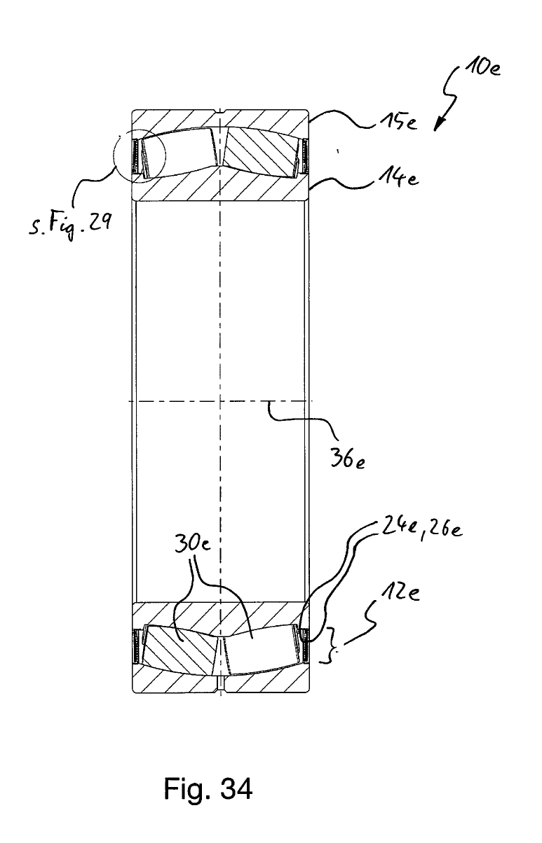

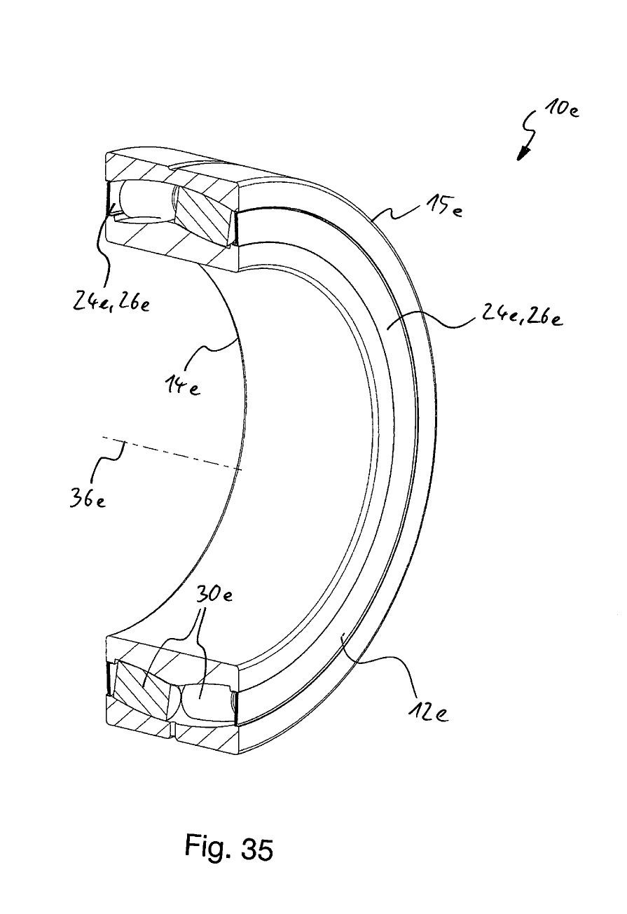

FIG. 33 shows the rolling-element bearing 10e including the seal unit 12e in overview. FIG. 34 shows a cross-section through the rolling-element bearing 10e including the seal unit 12e in side view. FIG. 35 shows a perspective view of the seal unit 12e in a rolling-element bearing 10e.

Some exemplary embodiments presented here, as shown in the Figures, make possible a simple integration of a wear-resistant seal unit 12a; 12b; 12c; 12d; 12e into an existing rolling-element bearing 10a; 10b; 10c; 10d; 10e. Due to the simple structure, the concept can be used on any rolling-element bearing, independent of design, bearing series, and diameter. Exemplary embodiments could thus be usable flexibly.

In contrast to variants for sealing rolling-element bearings including cover plates, wherein no recess is incorporated, with the seal variants presented here a metering or throttling function for defined lubricant escape could be formed by appropriate dimensioning of the gap. Lubricant could thus not simply escape unhindered but will be subjected to a significantly increased flow resistance due to the labyrinthine structure.

In comparison to the conventional solution of the external labyrinth seal, e.g. in wind turbines, further advantages could result. The space to be filled with lubricant could be significantly reduced, resulting in the need for less lubricant. In some exemplary embodiments the seal unit 12a; 12b; 12c; 12d; 12e is also made from a light material. This could lead to a reduction of material costs, a weight reduction, and thus to a simplified, time-efficient installation. A factory pre-fitting could reduce the risk of a contamination during installation of the otherwise unsealed, open bearing.

Using the economical seal designed proposed in some exemplary embodiments, a mass production of the seal unit 12a; 12b; 12c; 12d; 12e, e.g. by stamping, could be made possible. Even in low quantities the seal unit 12a; 12b; 12c; 12d; 12e could be economically manufactured, for example by laser-cutting.

In the exemplary embodiments discussed above, the design could additionally allow for a rudimentary centering of the seal unit 12a; 12b; 12c; 12d; 12e. A high-precision positioning of the seal unit 12a; 12b; 12c; 12d; 12e relative to the inner ring 14a; 14b; 14c; 14d; 14e could be avoided. Consequently cost-intensive processing steps could be omitted on the rolling-element bearing inner ring and outer ring. The required recess could be produced using machining manufacturing process, such as for example soft-turning prior to hardening.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved seals for bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

| 10a; 10b; 10c; 10d; 10e | Rolling-element bearing |
|---|---|
| 12a; 12b; 12c; 12d; 12e | Seal unit |
| 14a; 14b; 14c; 14d; 14e | Inner bearing ring |
| 15a; 15b; 15c; 15d; 15e | Outer bearing ring |
| 16a; 16b; 16c; 16d; 16e | Element |
| 18a; 18b; 18c; 18d; 18e | Seal gap |
| 20a; 20c | Recess |
| 22a; 22c | Seal lip |
| 23b; 23d; 23e | Seal surface |
| 24b; 24d; 24e | First delimiting element |
| 26b; 26d; 26e | Second delimiting element |
| 28b | Third delimiting element |
| 30a; 30b; 30c; 30d; 30e | Rolling elements |
| 32a; 32b; 32c; 32d; 32e | Bearing cage |
| 34e | Flocking |
| 36a; 36b; 36c; 36d; 36e | Central axis |
| 38e | Seal lip |
| 112 | Large bearing |
| 114 | Labyrinth ring |
| 116 | V-ring |
| 120 | Bearing ring |
| 130 | Rolling elements |
| 140 | Labyrinth |

What is claimed is:

1. A rolling-element bearing including a seal unit, wherein the rolling-element bearing comprises:
at least one bearing ring; and
a further bearing ring tiltable with respect to the at least one bearing ring by a limited angle, and
wherein the seal unit comprises:
an at least part-ring shaped element attached to the bearing ring,
wherein the at least part-ring shaped element delimits a labyrinthine seal gap and corresponds to a first delimiting element, and
wherein the rolling-element bearing further includes a second delimiting element and a third delimiting element, the third delimiting element being attached to a bearing cage, and
wherein the seal gap extends at least partially between the first delimiting element, the second delimiting element and the third delimiting element.

2. The rolling-element bearing according to claim 1, wherein at least part of the seal gap does not extend beyond the bearing ring in the axial direction or wherein the at least part-ring shaped element is formed plate-shaped.

3. The rolling-element bearing according to claim 1, wherein the seal gap is additionally delimited by a recess in the bearing ring or wherein the bearing ring includes a seal lip in abutment with the at least part-ring shaped element.

4. The rolling-element bearing according to claim 1, wherein the at least part-ring shaped element has a change of direction along its course of at least 45 degrees.

5. The rolling-element bearing according to claim 1, wherein the seal gap additionally includes a flocking or a seal lip.

6. The rolling-element bearing according to claim 1, wherein at least the at least part-ring shaped element is exchangeably attached to the bearing ring.

7. The rolling-element bearing according to claim 1, wherein the rolling-element bearing has an outer diameter of at least 400 millimeters.

8. The rolling-element bearing according to claim 1,
wherein at least part of the seal gap does not extend beyond the bearing ring in the axial direction;
wherein the at least part-ring shaped element is plate-shaped,
wherein the seal gap is additionally delimited by a recess in the bearing ring,
wherein the bearing ring includes a seal lip in abutment with the at least part-ring shaped element,
wherein the at least part-ring shaped element has a change of direction along its course of at least 45 degrees,
wherein the seal gap additionally includes a flocking or a seal lip,
wherein the at least part-ring shaped element is exchangeably attached to the bearing ring, and
wherein the rolling-element bearing has an outer diameter of at least 400 millimeters.

9. A rolling-element bearing including a seal unit,
the rolling-element bearing comprising a first bearing ring and a second bearing ring, the second bearing ring being tiltable relative to the first bearing ring by an angle, and
the seal unit comprising a first delimiting element comprising an at least part-ring shaped element attached to the bearing ring, the at least part-ring shaped element forming a portion of a labyrinthine seal gap, and
the rolling-element bearing further including a second delimiting element and a third delimiting element, the third delimiting element being attached to a bearing cage,
wherein the seal gap extends at least partially between the first delimiting element, the second delimiting element and the third delimiting element.

10. The rolling-element bearing according to claim 9, wherein a first portion of the seal gap extends between the first delimiting element and the second delimiting element and a second portion of the seal gap extends between the second delimiting element and the third delimiting element.

11. The rolling-element bearing according to claim 9, wherein the seal gap does not extend beyond the bearing ring in the axial direction.

12. The rolling-element bearing according to claim 9, wherein the at least part-ring shaped element is plate-shaped.

13. The rolling-element bearing according to claim 10, wherein the first and second portions of the seal gap do not extend beyond the bearing ring in the axial direction.

14. The rolling-element bearing according to claim 10, wherein
the bearing ring includes a seal lip in abutment with the at least part-ring shaped element,
the at least part-ring shaped element has a change of direction along its course of at least 45 degrees,
the seal gap includes a flocking or a seal lip,
the at least part-ring shaped element is exchangeably attached to the bearing ring, and
the rolling-element bearing has an outer diameter of at least 400 millimeters.
